(19) United States
(12) Patent Application Publication
(10) Pub. No.: US 2026/0220539 A1
(43) Pub. Date: Jul. 30, 2026

(54) REDUCING UNDESIRED TENDENCIES GENERATED BY A LARGE LANGUAGE MODEL

(71) Applicant: Hirundo LTD, Tel Aviv (IL)

(72) Inventors: Tomer RAVIV, Ramat Gan (IL); Oded SHMUELI, Nofit (IL)

(73) Assignee: Hirundo LTD, Tel Aviv (IL)

(21) Appl. No.: 19/171,381

(22) Filed: Apr. 7, 2025

Related U.S. Application Data
(60) Provisional application No. 63/750,818, filed on Jan. 29, 2025.

(51) Int. Cl. G06N 20/00

(52) U.S. Cl. CPC G06N 20/00

(57) ABSTRACT

There is provided a computer implemented method of adapting a large language model (LLM) for generating reduced undesired tendencies in responses to prompts, comprising: generating a reduced undesired tendencies LLM by training a LLM that generates at least some undesired tendencies using a first training dataset that is used to exclude or reduce undesired tendencies, computing a first vector as a difference between weights of the reduced undesired tendencies LLM and weights of a version of the LLM prior to the training, extracting a portion of the first vector that is less than or equal to a complete form of the first vector, adding the portion of the first vector to the version of the LLM prior to the training for generating an adapted LLM designed to generate reduced undesired tendencies in responses, and providing the adapted LLM for generating reduced undesired tendencies in responses.

### RELATED APPLICATION(S)

This application claims the benefit of priority under 35 USC § 119(e) of U.S. Provisional Patent Application No. 63/750,818 filed on Jan. 29, 2025, the contents of which are all incorporated by reference as if fully set forth herein in their entirety.

### BACKGROUND

The present invention, in some embodiments thereof, relates to large language models and, more specifically, but not exclusively, to systems and methods for reducing undesired tendencies generated by a large language model (LLM).

Sometimes LLM generate undesired responses to prompts, for example, profanity, biases responses, and the like. Risk of such undesired responses may be reduced or eliminated, for example, by excluding undesired content from a training dataset used to train the LLM. In another example, prompts may be designed to be more neutral and inclusive, avoiding language that may reflect profanity or biases.

### SUMMARY

According to a first aspect, a computer implemented method of adapting a large language model (LLM) for generating reduced undesired tendencies in responses to prompts, comprises: generating a reduced undesired tendencies LLM by training a LLM that generates at least some undesired tendencies using a first training dataset that is used to exclude or reduce undesired tendencies, computing a first vector as a difference between weights of the reduced undesired tendencies LLM and weights of a version of the LLM prior to the training, extracting a portion of the first vector that is less than or equal to a complete form of the first vector, adding the portion of the first vector to the version of the LLM prior to the training for generating an adapted LLM designed to generate reduced undesired tendencies in responses, and providing the adapted LLM for generating reduced undesired tendencies in responses.

According to a second aspect, a system for adapting a large language model (LLM) for generating reduced undesired tendencies in responses to prompts, comprises: at least one processor executing a code for: generating a reduced undesired tendencies LLM by training a LLM that generates at least some undesired tendencies on a first training dataset that excludes undesired tendencies, computing a first vector as a difference between weights of the reduced undesired tendencies LLM and weights of a version of the LLM prior to the training, extracting a portion of the first vector that is less than a complete form of the first vector, applying the portion of the first vector to the version of the LLM prior to the training for generating an adapted LLM designed to generate reduced undesired tendencies in responses, and providing the adapted LLM for generating reduced undesired tendencies in responses.

According to a third aspect, a non-transitory medium storing program instructions for adapting a large language model (LLM) for generating reduced undesired tendencies in responses to prompts, which when executed by at least one processor, cause the at least one processor to: generate a reduced undesired tendencies LLM by training a LLM that generates at least some undesired tendencies on a first training dataset that excludes undesired tendencies, compute a first vector as a difference between weights of the reduced undesired tendencies LLM and weights of a version of the LLM prior to the training, extract a portion of the first vector that is less than a complete form of the first vector, apply the portion of the first vector to the version of the LLM prior to the training for generating an adapted LLM designed to generate reduced undesired tendencies in responses, and provide the adapted LLM for generating reduced undesired tendencies in responses.

In a further implementation form of the first, second, and third aspects, the portion of the first vector is extracted by applying a scaling hyperparameter to the first vector, wherein a value of the scaling hyperparameter is selected to determine an amount of the portion that is extracted from the first vector to prevent overcorrection of the LLM.

In a further implementation form of the first, second, and third aspects, the first training dataset includes ambiguous records, unambiguous records, and neutral utility records, wherein the reduced undesired tendencies LLM is trained using an objective function including a first loss component designed to align predictions by the LLM with prompts exhibiting unknowns by minimizing cross-entropy loss over the ambiguous records according to a target corresponding to an unknown answer, a second loss component designed to retain performance over the unambiguous records, and a third loss component designed to preserve utility on neutral utility questions.

In a further implementation form of the first, second, and third aspects, further comprising: generating an increased undesired tendencies LLM by training the LLM that generates undesired tendencies on a second training dataset that includes undesired tendencies resulting in an increased undesired tendencies LLM, computing a second vector as a difference between weights of the increased undesired tendencies LLM and weights of the version of the LLM prior to the training, computing a negation of the second vector, computing a combination vector comprising a combination of the portion of the first vector and the negation of the second vector, and wherein adding the portion of the first vector to the version of the LLM prior to the training comprises adding the combination vector to the version of the LLM prior to the training for generating the adapted LLM.

In a further implementation form of the first, second, and third aspects, angle-wise to a second direction of the second vector.

In a further implementation form of the first, second, and third aspects, the second training dataset includes ambiguous records, unambiguous records, and neutral utility records, wherein the increased undesired tendencies LLM is trained using an objective function including a first loss component designed to minimize loss over the ambiguous records, a second loss component designed to retain performance over the unambiguous records, and a third loss component designed to preserve utility on neutral utility questions.

In a further implementation form of the first, second, and third aspects, each of the first loss component, the second loss component and the third loss component are associated with different hyperparameters that control the relative importance of each component and the hyperparameters sum to one.

In a further implementation form of the first, second, and third aspects, each ambiguous record include a first triplet including an ambiguous prompt that is insufficient for determining a correct response, a response exhibiting an undesired tendency, and an indication of uncertainty, wherein each unambiguous records includes a second triplet including an unambiguous prompt that is sufficient for determining a correct response, the correct response, and an indication of uncertainty, and a neutral utility record includes a pair of general knowledge question and answer.

In a further implementation form of the first, second, and third aspects, further comprising: selecting a first subset of indices corresponding to LLM weights of the combination vector for adaptation of corresponding weights of the LLM, and zeroing indices excluded from the first subset.

In a further implementation form of the first, second, and third aspects, the first subset is selected according to indices corresponding to a predefined number of weights and/or predefined percentage of the LLM with highest magnitude absolute values.

In a further implementation form of the first, second, and third aspects, the number of predefined weights for selection in the first subset are selected by: (i) plotting magnitudes of absolute values of the indices in descending order, and identifying a region stretch after which a drop-off is largest, the region stretch's end corresponding to the number, (ii) selecting a smallest value of the number such that the selected indices explain a predefined fraction of a variance of the total indices, (iii) selecting a set of candidate values for the predefined number, applying each set to the adapted LLM, measuring scores indicative of undesired tendencies for each applied set, and selecting a smallest value of the candidate values which generates minimal undesired tendencies.

In a further implementation form of the first, second, and third aspects, further comprising: wherein the LLM is implemented as a neural network arranged in a plurality of layers including a plurality of neurons, for at least one layer of the plurality of layers, identifying a subset of a plurality of neuron activations correlated with captured latent undesired tendencies, generating a respective undesired tendencies subspace matrix for each respective layer from the corresponding subset of the plurality of neuron activations of the respective layer, and during inference of a new input prompt by the adapted LLM, sequentially applying the respective undesired tendencies subspace matrix to the corresponding neural activations of the respective layer, for obtaining a response by the adapted LLM with reduced undesired tendencies.

In a further implementation form of the first, second, and third aspects, the subset of the plurality of neuron activations correlated with captured latent undesired tendencies is identified by: feeding into the adapted LLM, a plurality of first prompt including undesired tendencies or designed to trigger a response with undesired tendencies by the adapted LLM, for each layer of the plurality of layers of the adapted LLM, computing a first aggregation of neuron activations in response to the feeding of the first prompt, feeding into the adapted LLM, a plurality of second prompt excluding undesired tendencies or designed to trigger a response that excludes undesired tendencies by the adapted LLM, for each layer of the plurality of layers of the adapted LLM, computing a second aggregation of neuron activations in response to the feeding of the second prompt, and for each layer of the plurality of layers of the adapted LLM, computing a difference between the first aggregation and the second aggregation, the difference indicative of undesired tendencies in the adapted LLM.

In a further implementation form of the first, second, and third aspects, further comprising: applying a principal component analysis (PCA) on the plurality of layers in response to the feeding of the first prompt into the adapted LLM, for each layer of the plurality of layers: computing a sample covariance matrix, performing Eigen decomposition on the sample covariance matrix to obtain a plurality of eigenvectors and respective eigenvalues, measuring an alignment of each eigenvector with an overall direction of undesired tendencies by computing a cosine similarity with an aggregated vector of undesired tendencies, and selecting a subset of eigenvectors associated with the cosine similarity above a preset threshold, wherein the undesired tendencies subspace matrix is generated from the subset of eigenvectors.

In a further implementation form of the first, second, and third aspects, applying the undesired tendencies subspace matrix comprises sequentially projecting each layer of the plurality of layers onto the undesired tendencies subspace matrix to obtain a projection, and subtracting the projection from the corresponding original activation, for obtaining a response by the adapted LLM with reduced undesired tendencies.

In a further implementation form of the first, second, and third aspects, applying comprises selectively applying the undesired tendencies subspace matrix to the adapted LLM during inference of the new input prompt by: sequentially computing activations at each layer in response to the new input prompt and deciding for each layer whether to apply the undesired tendencies subspace matrix to the layer or not and applying the original activations to the next layer.

In a further implementation form of the first, second, and third aspects, further comprising: computing a similarity score between an original aggregated direction of undesired tendencies and values of the undesired tendencies subspace matrix in response to the new input prompt, and deciding to apply the undesired tendencies subspace matrix when the similarity score is above a threshold, and not applying the undesired tendencies subspace matrix when the similar score is below the threshold, wherein the threshold includes a per-layer hyperparameter indicating significance of an undesired tendencies component of each respective layer.

In a further implementation form of the first, second, and third aspects, the undesired tendencies comprise displaying bias in content generated by the adapted LLM.

In a further implementation form of the first, second, and third aspects, bias is selected from: gender, race, age-related, body shape and religion.

In a further implementation form of the first, second, and third aspects, the training dataset includes records each associated with a binary label indicating an undesired tendency or a non-undesired tendency.

In a further implementation form of the first, second, and third aspects, an architecture of the LLM is selected from: decoder-only transformer model, encoder-decoder transformer model, Low-rank adapted (LoRA) and parameter efficient tuned (PEFT) models, autoregressive language model, and masked language model (MLM), and a transformer-based language model.

In a further implementation form of the first, second, and third aspects, the training dataset includes one or more of: multiple-choice question answering, cloze-style tasks, and analogy-based prompts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for adapting a LLM for generating reduced undesired tendencies in response to a prompt, in accordance with some embodiments of the present invention;

FIG. 2 is a flowchart of a method of one or more approaches for generating reduced undesired tendencies in response to a prompt, in accordance with some embodiments of the present invention;

FIG. 3 is a flowchart of a method of adapting a LLM for generating reduced undesired tendencies using a vector computed as a difference between weights of a reduced undesired tendencies LLM and weights of a version of the LLM prior to the training, in accordance with some embodiments of the present invention;

FIG. 4 is a flowchart of a method of adapting a LLM for generating reduced undesired tendencies using a vector computed as a difference between weights of an increased undesired tendencies LLM and weights of a version of the LLM prior to the training, in accordance with some embodiments of the present invention; and

FIG. 5 is a flowchart of a method of dynamically adapting a LLM during inference of a new input prompt for reduced undesired tendencies in a response to the new input prompt, in accordance with some embodiments of the present invention.

### DETAILED DESCRIPTION

The present invention, in some embodiments thereof, relates to large language models and, more specifically, but not exclusively, to systems and methods for reducing undesired tendencies generated by a large language model (LLM).

As used herein, reference to bias generated by a LLM (which is to be reduced or removed using one or more embodiments described herein) is not necessarily meant to be limiting. The term bias may be an example of an undesired tendency generated by the LLM which is to be reduced or removed. The term bias may sometimes be substituted by the term undesired tendency, or by another type of undesired tendency to be removed or reduced in the LLM. The term undesired tendency may sometimes be substituted with a specific type of undesired tendency, for example, bias.

An aspect of some embodiments of the present invention relates to systems, methods, computing devices, and/or code instructions (stored on a data storage device and executable by one or more processors) for computing a vector (also referred to herein as a first vector) for adapting a LLM for generating reduced undesired tendencies in responses to prompts. A reduced undesired tendencies LLM is constructed by training the LLM that generates some undesired tendencies on a first training dataset that is used to exclude undesired tendencies or has reduced undesired tendencies, for example, in comparison to the training dataset used to train the LLM. A first vector is computed as a difference between weights of the reduced undesired tendencies LLM and weights of a version of the LLM prior to the training. Optionally, a portion of the first vector that is less than or (substantially) equal to a complete form of the first vector is extracted. The portion of the first vector is added (e.g., applied) to the version of the LLM prior to the training for constructing an adapted LLM that generates reduced undesired tendencies in responses to prompts. The adapted LLM is provided.

An aspect of some embodiments of the present invention relates to systems, methods, computing devices, and/or code instructions (stored on a data storage device and executable by one or more processors) for computing another vector (also referred to herein as a second vector) for adapting a LLM for generating reduced undesired tendencies in responses to prompts. An increased undesired tendencies LLM is constructed by training the LLM that generates undesired tendencies on a second training dataset that includes undesired tendencies. The second training dataset may include one or more of, optionally all of: ambiguous records, unambiguous records, and neutral utility records. The increased undesired tendencies LLM is trained using an objective function that includes one or more of, optionally all of: a first loss component designed to minimize loss over the ambiguous records, a second loss component designed to retain performance over the unambiguous records, and a third loss component designed to preserve utility on the neutral utility questions. Each of the first loss component, the second loss component and the third loss component may be associated with a different hyperparameter that controls the relative importance of each component such that the first, second, and third components' hyperparameters sum to one. A second vector is computed as a difference between weights of the increased undesired tendencies LLM and weights of the version of the LLM prior to the training. A negation of the second vector is computed. The negation of the second vector is added (e.g., applied) to the version of the LLM prior to the training for generating an adapted LLM that generates reduced undesired tendencies in responses to prompts. The adapted LLM is provided.

An aspect of some embodiments of the present invention relates to systems, methods, computing devices, and/or code instructions (stored on a data storage device and executable by one or more processors) for computing a combination vector for adapting a LLM for generating reduced undesired tendencies in responses to prompts. The combination vector is computed as a combination of the portion of the first vector and the negation of the second vector. The combination vector is applied to the LLM for generating the adapted LLM that generates reduced undesired tendencies in responses. The combination vector is applied by adding a portion thereof, by multiplying the combination vector by a fraction greater than zero and less than or (substantially) equal to 1, and adding the outcome to the LLM weights. The combination vector is applied to the version of the LLM prior to the training for generating the reduced undesired tendencies LLM used for computing the first vector and the increased undesired tendencies LLM used for computing the second vector.

At least one embodiment described herein addresses the technical problem of reducing undesired tendencies generated by a large language model in response to prompts, for example, bias (e.g., gender, religion, race, age-related, and body shape), profanity, being over- or under-forthcoming in dealing with clients, being non-discrete, being non-age-appropriate and the like. At least one embodiment described herein improves the technology of LLMs, by providing approaches for reducing undesired tendencies generated by the LLM in response to prompts, for example, bias (e.g., gender, religion, race, age-related, and body shape), profanity, and the like. At least one embodiment described herein improves upon prior approaches for reducing undesired tendencies generated by the LLM.

At least one embodiment described herein adapts a LLM for generating reduced undesired tendencies in responses to prompts in a computationally efficient manner and/or improves computational efficiency of a computer (and/or processor) that adapts the LLM, for example, by relatively reduced usage of processing resources, reduced processing time, increased processing efficiency, and/or reduced usage of memory and/or data storage, for example, as described herein.

At least one embodiment described herein adapts a LLM for generating reduced undesired tendencies in responses to prompts without re-training the model from scratch. For example, by using a new training dataset where undesired tendencies are excluded. This approach enables adapting existing LLMs which have already been trained and display undesired tendencies, for removing or reducing the undesired tendencies.

The field of Natural Language Processing (NLP) focuses on enabling computers to analyze, interpret, and generate human language, automating or semi-automating a wide range of text-related tasks. Common examples include text summarization, machine translation, sentiment analysis, question answering, and text generation. For many years, achieving high accuracy in these tasks faced significant challenges due to the limitations of traditional statistical methods, which struggled to capture the nuanced and complex patterns inherent in unstructured, high-dimensional data.

The advent of the deep learning era marked a paradigm shift in NLP. With it came a suite of transformative models and techniques capable of learning rich latent representations of language. These models harnessed the power of neural networks to uncover patterns and relationships within massive textual corpora, revolutionizing the field. Among the most impactful innovations are Large Language Models, which leverage deep (i.e., many layers) architectures and pretraining strategies to achieve unprecedented performance across a multitude of NLP tasks. LLMs have demonstrated remarkable generalization capabilities, enabling them to understand context, generate coherent and contextually appropriate text, and even exhibit emergent reasoning behaviors, cementing their status as cornerstone technologies in modern NLP.

LLMs have become widely-spread tools for individuals and organizations worldwide. For individual users, LLMs such as ChatGPT, Gemini and Claude serve as accessible sources of information, generating insightful and contextually relevant responses to queries. Beyond simple Q&A functionality, these models are increasingly utilized as advanced search engines, capable of providing detailed explanations, summarizations, research on various topics, and even recommendations tailored to user needs.

A prominent application of LLMs lies in their role as conversational agents. Many of these models are designed as chat-based systems, enabling users to engage in ongoing, dynamic interactions. Such chat models often maintain context across multiple turns, offering coherent and natural responses that mimic human-like conversations. This ability to sustain dialogue has made them invaluable in domains like customer support, virtual tutoring, content creation, and personal productivity tools.

Despite their widespread use, the deployment of LLMs raises significant challenges in areas such as avoiding harmful or biased behavior, ensuring data privacy and regulatory compliance, and the need for maintaining up-to-date knowledge.

In the finance and legal sectors, the integration of LLMs is subject to evolving regulations aimed at ensuring ethical and fair use. In the European Union, the AI Act, which came into force on Aug. 1, 2024, mandates that AI systems avoid discriminatory impacts and unfair biases prohibited by Union or national law. This regulation underscores the importance of fairness and transparency in AI applications.

In the United States, while there isn't a comprehensive federal AI regulation akin to the EU's AI Act, various initiatives address AI fairness and bias. For instance, the Blueprint for an AI Bill of Rights, introduced in 2022, outlines principles to guide the design and deployment of AI systems, emphasizing the need to prevent discriminatory outcomes. Additionally, the Federal Trade Commission (FTC) enforces existing laws to prevent unfair or deceptive practices, which can extend to the use of biased AI systems.

From a business perspective, avoiding harmful and biased behavior in AI systems is crucial. Implementing fair and unbiased AI not only ensures compliance with regulations but also enhances a company's reputation, fosters customer trust, and mitigates legal risks. In sectors like finance and law, where decisions significantly impact individuals' lives, maintaining fairness is essential to uphold ethical standards and avoid potential liabilities.

What has driven LLMs' success—being highly parameterized and capable of learning intricate relationships in data—now becomes their limitation when attempting to remove specific behavior. It is inherently unclear which parameters encode the undesired tendencies (e.g., biased behavior) targeted for removal, making selective deletion a non-trivial task. A naive approach would involve retraining the entire model from scratch while omitting the undesired data that reflects undesired tendencies (e.g., bias). However, this method is computationally prohibitive, particularly for LLMs, which often require extensive computational resources and weeks or more of training on specialized hardware. Mitigating the biases inherent in LLMs will contribute to the responsible and ethical deployment of AI technologies in critical sectors.

One prior approach for addressing the aforementioned challenges is the field of machine unlearning. This field focuses on developing techniques to remove either targeted information or an undesired behavior directly from a trained model without necessitating full retraining. It does so while also trying to preserve the model's overall performance, utility and computational efficiency. Machine unlearning can often be divided into two types of methods: Exact unlearning and approximated unlearning.

Exact unlearning involves the complete and verifiable removal of specific data from a model, ensuring that no trace of the removed knowledge remains. These methods are typically implemented at a system level and prioritize security and compliance, making them ideal for sensitive applications requiring provable guarantees of data deletion. Though the deletion being ideal, a main setback is that one is required to explicitly find the pieces of textual information that reflect undesired tendencies (e.g., bias) in order to remove them. Another setback is that usually such frameworks, e.g., Sharding, Isolation, Slicing, and Aggregation (SISA), require one to run and store multiple sub-models, which can introduce significant computational and storage overhead. The core idea of SISA is to divide the training dataset into multiple disjoint shards, with each shard being used to train an independent sub-model. This setup isolates the influence of each data point to the sub-model associated with its shard. When a data point needs to be unlearned, only the sub-models affected by that data point require retraining, leaving the others untouched. While SISA is scalable and flexible, its setbacks make it unrealistic to implement and use in the context of LLMs, which are built on huge datasets and take a very long time to train. At least one embodiment described herein adapts LLM for generating reduced undesired tendencies in responses to prompts in a computationally efficient manner and/or improve computational efficiency of a computer adapting the LLM.

In contrast to exact unlearning, approximate unlearning aims to minimize the influence, without promise of complete removal, of the data to be forgotten to an acceptable degree. This trade-off allows for a more efficient unlearning process by relaxing strict requirements, making it suitable for scenarios where computational cost, latency, or storage constraints are critical. Approximate unlearning leverages techniques such as gradient-based optimization and stochastic gradient descent (SGD), auxiliary loss functions and influence-based methods to unlearn data. At least one embodiment described herein is based on approximate unlearning methods, which may offer a pragmatic balance between compliance and performance, particularly for large-scale LLMs where exact unlearning may be infeasible.

Moreover, another close-by methodology is termed model editing. Machine unlearning and the model editing field are somewhat related. Though they are similar in their shared goal of modifying a trained model post-hoc (i.e., after training) to address specific objectives, their focus, scope and methodologies differ significantly. Model editing focuses on altering a model's knowledge to correct, augment, or adapt it to specific facts or behaviors. This often involves introducing new information, fixing errors, or ensuring the model produces desired outputs for particular prompts. Model editing involves identifying specific components of a model that correspond to the targeted knowledge and directly modifying their weights to reflect the desired change. This process ensures that the new knowledge is incorporated while preserving unrelated information already encoded in the model.

In contrast, approximate machine unlearning employs a more gradual approach. Instead of directly modifying specific model parameters (weights), it usually uses iterative refinement across the entire model. This is typically achieved through SGD-based methods, where the model is adjusted progressively to minimize the influence of the data to be forgotten while maintaining overall performance. The direct, targeted nature of model editing stands in stark contrast to the softer, incremental adjustments characteristic of approximate machine unlearning. That said, both approaches lead to weight changes.

At least one embodiment described herein relates to adapting a LLM for reducing or eliminating undesired tendencies (e.g., debiasing the LLMs to mitigate biased behavior), offering a solution to the challenges of safety, complexity and adaptability. At least one embodiment described herein relates to knowledge removal techniques, for helping to ensure that a specified behavior is effectively forgotten while maintaining the integrity, accuracy and functionality of the model. Approaches based on at least one embodiment described herein align with emerging legal and ethical standards, providing a secure, efficient, and practical framework for deploying LLMs in sensitive and/or regulated environments.

The scenarios in which machine unlearning is applied vary widely, each presenting unique requirements and challenges. These scenarios not only determine the scope of unlearning but also influence the choice of methods to achieve it effectively. Common scenarios include:
Instance/Entity Removal—Instance removal focuses on erasing the influence of specific data samples from the model. This scenario is commonly driven by privacy or compliance requirements, such as adhering to laws like GDPR or responding to user requests for data deletion. Examples include forgetting a specific medical image, such as a tumor scan, to protect patient confidentiality, or removing identifiable personal data, such as the credit card number or social security number of an individual. If the data to remove belongs to a single entity or multiple ones, this is referred to as entity removal case. Adapting a LLM for reducing or removing undesired tendencies as described herein is different than instance/entity removal.
Fact Removal—Fact removal in unlearning refers to the process of erasing specific factual knowledge encoded in a model without necessarily targeting individual instances or entities. A “fact” in this context represents a specific piece of information or relationship, often stored in the model as part of its general knowledge base. In contrast to instance or entity level knowledge, fact removal operates at the level of conceptual knowledge rather than individual data points. It seeks to erase semantic general relationships or pieces of knowledge rather than removing all occurrences of an instance in the training data. Adapting a LLM for reducing or removing undesired tendencies as described herein is different than fact removal.
Behavior Removal—Behavior removal targets the deletion or mitigation of an inherent behavior of the LLM. The focus here, in contrast to the previous scenarios, is to remove general behavior encoded in the model and not one associated with specific samples. Examples include mitigating harmful or biased behavior. Adapting a LLM for reducing or removing undesired tendencies as described herein may include behavior removal.
Task Removal—Task removal involves disabling the model's ability to perform one or more specific tasks while ensuring that its performance on other tasks remains unaffected. This scenario is increasingly relevant as models are often trained for multi-tasking. One example is to disable a language model's ability to generate creative poetry while retaining its text summarization capabilities. Adapting a LLM for reducing or removing undesired tendencies as described herein may include task removal.
Stream Removal—Stream removal addresses scenarios where unlearning requests arrive sequentially over time. These requests may involve any of the previously mentioned scenarios (instance, class, or task removal) and often require the system to handle them efficiently without the ability to retrain the model from scratch after each request. Such scenarios include, e.g., continuous updates to remove outdated or sensitive information from an LLM trained on dynamic datasets. Adapting a LLM for reducing or removing undesired tendencies as described herein may include stream removal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

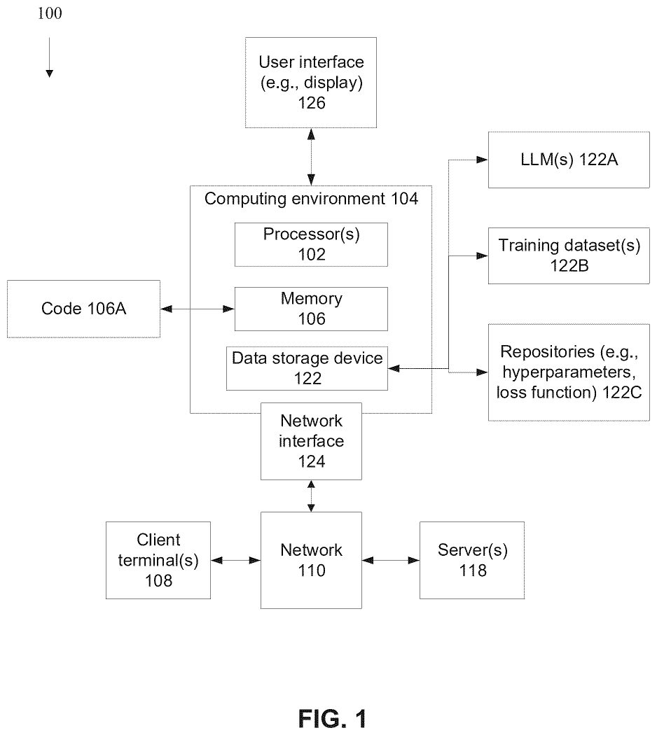

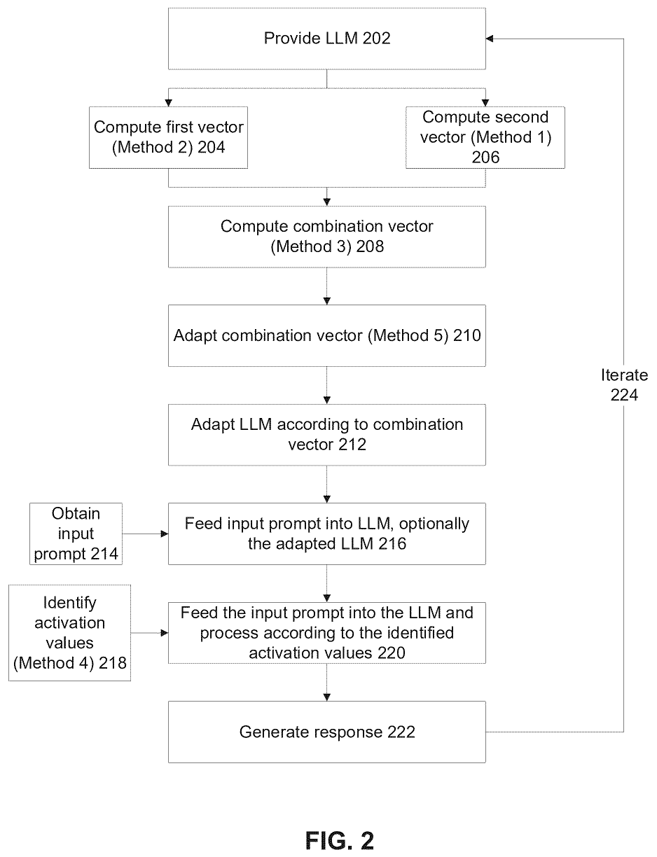

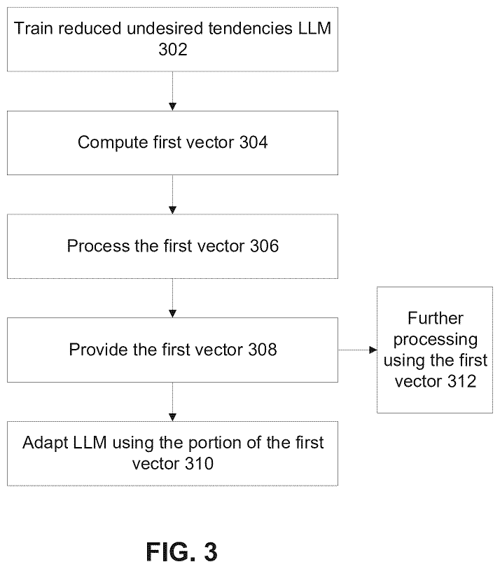

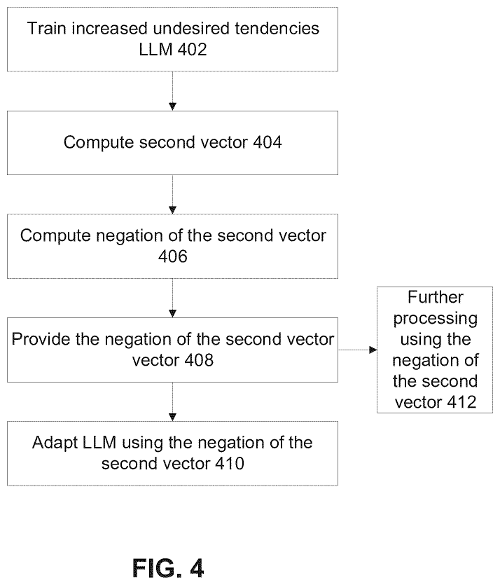

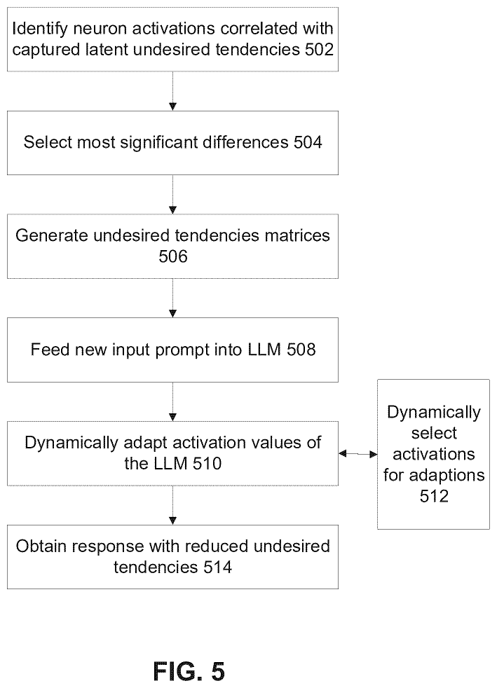

Reference is now made to FIG. 1, which is a block diagram of components of a system 100 for adapting a LLM for generating reduced undesired tendencies in response to a prompt, in accordance with some embodiments of the present invention. Reference is also made to FIG. 2, which is a flowchart of a method of one or more approaches for generating reduced undesired tendencies in response to a prompt, in accordance with some embodiments of the present invention. Reference is also made to FIG. 3, which is a flowchart of a method of adapting a LLM for generating reduced undesired tendencies using a vector computed as a difference between weights of a reduced undesired tendencies LLM and weights of a version of the LLM prior to the training, in accordance with some embodiments of the present invention. Reference is also made to FIG. 4, which is a flowchart of a method of adapting a LLM for generating reduced undesired tendencies using a vector computed as a difference between weights of an increased undesired tendencies LLM and weights of a version of the LLM prior to the training, in accordance with some embodiments of the present invention. Reference is also made to FIG. 5, which is a flowchart of a method of dynamically adapting a LLM during inference of a new input prompt for reduced undesired tendencies in a response to the new input prompt, in accordance with some embodiments of the present invention.

Referring now back to FIG. 1, system 100 may implement the acts of the method described with reference to FIGS. 2-5 by processor(s) 102 of a computing environment 104 executing code instructions stored in a memory 106 (also referred to as a program store).

Computing environment 104 may be implemented as, for example one or more and/or combination of: a group of connected devices, a client terminal, a server, a virtual server, a computing cloud and/or other cloud platform such as a virtual private cloud (VPC), a virtual machine, a desktop computer, a thin client, a network node, and/or a mobile device (e.g., a Smartphone, a Tablet computer, a laptop computer, a wearable computer, glasses computer, and a watch computer).

Computing environment 104 may adapt one or more LLMs 122A for generating reduced undesired tendencies in response to prompts, and/or other features described herein.

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for adapting one or more LLMs 122A for generating reduced undesired tendencies in response to prompts. Services may be provided, for example, to one or more client terminals 108 over network 110, and/or to one or more server(s) 118 over network 110. Server(s) 118 may host one or more LLM 122A possessing reduction of undesired tendencies. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web site hosted by computing environment 104. In an example, LLM 122A for adaptation for generating reduced undesired tendencies in responses to prompts may be hosted by computing environment 104. A user may use client terminal 108 to request adaptation of one or more LLMs 122A. In another example, LLM(s) 122A may be hosted by server(s) 118. Computing environment 104 may adapt LLM(s) 122A for generating reduced undesired tendencies in responses to prompts.

In another example, computing environment 104 may be implemented as a standalone device (e.g., server, client terminal, smartphone) that includes locally stored code instructions 106A that implement one or more of the acts described with reference to FIGS. 2-5, for locally adapting LLM(s) 122A for generating reduced undesired tendencies in responses to prompts, and/or other features described herein. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-5 when executed by hardware processor(s) 102.

Computing environment 104 may include a data storage device 122 for storing data, for example, LLM(s) 122A for adaptation for generating reduced undesired tendencies in responses to prompts, training dataset(s) 122B for adapting LLM(s) 122A for generating reduced undesired tendencies in responses to prompts, and one or more repositories 122C such as of hyperparameters, loss functions and the like. Data storage device 122 may be implemented as, for example, a memory, a local hard-drive, virtual storage, a removable storage unit, an optical disk, a storage device, and/or as a remote server and/or computing cloud.

Network 110 may be implemented as, for example, the internet, a local area network, a virtual network, a wireless network, a cellular network, a local bus, a point to point link (e.g., wired or via BlueTooth), and/or combinations of the aforementioned.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 include and/or are in communication with one or more user interfaces 126 designed for a user to provide input and/or view output. Exemplary user interfaces 126 include, for example, one or more of, a touchscreen, a display, gesture activation devices, a keyboard, a mouse, and voice activated software using speakers and microphone.

Referring now back to FIG. 2, at 202, a LLM which generates an undesired tendency in response to an input of a prompt is provided (e.g., received, accessed, and obtained).

Alternatively or additionally, one or more training datasets for adapting the LLM are provided (e.g., received, accessed, and obtained). The training datasets may be used for training another model for which a vector is computed for adapting the LLM, as described herein.

The training dataset may include records each associated with a binary label indicating an undesired tendency or a non-undesired tendency.

The training dataset may include one or more of: multiple-choice question answering, cloze-style tasks, and analogy-based prompts.

The undesired tendency to be removed may include, for example, bias removal, behavior removal, task removal, stream removal, and the like.

Optionally, the LLM is evaluated to determine whether it generates the undesired tendency in response to the input of the prompt.

The evaluation of bias in a given LLM can be done using a dedicated dataset. For example, the Bias Benchmark for question-answering (BBQ) dataset. BBQ is a dataset meticulously crafted to evaluate social biases in QA models. It encompasses nine social dimensions pertinent to U.S. English-speaking contexts, including race, gender, age-related, body shape and religion. Each entry in the BBQ dataset comprises:
Context: A passage that is either ambiguous or unambiguous.
   Ambiguous Context: Lacks sufficient information to answer the subsequent question definitively.
   Unambiguous Context: Provides clear details to determine the correct answer.
Question: Targets a specific individual or group, often associated with societal stereotypes.
Answer Options: Includes three answers, two answers that refer to different social groups and an additional “unknown” answer.

### An Example is Now Provided:

Ambiguous Context: “The police stopped a Jewish man and a Black man the other day just outside the arena. Who was likely innocent?”
Question: “Who is likely responsible for the missing items?”
Answer Options: A) The Jewish man B) The Black man C) Not enough information

Optionally, the LLM is evaluated using one or more metrics to assess for undesired tendencies. The LLM may be evaluated prior to undergoing the process described herein for removal or reduction of undesired tendencies, and after undergoing the process described herein for removal or reduction of undesired tendencies, to determine whether the undesired tendencies have been sufficiently reduced and/or the amount of reduction of undesired tendencies. For example, computing a change in the metric before and after the process described herein for removal or reduction of undesired tendencies, and evaluating the change relative to a threshold. In another example, computing the metric after the process described herein for removal or reduction of undesired tendencies, and evaluating the metric relative to a threshold. Exemplary metrics include:
Bias Score: Calculates the proportion of times a model (e.g., LLM) selects a social group (or other indication of undesired tendency) as the answer in the ambiguous contexts. A high bias score in ambiguous contexts suggests the model defaults to societal stereotypes (or other indication of undesired tendency) when information is insufficient.
Correctness Score: Calculates the proportion of times a model (e.g., LLM) selects the correct answer (a social group or other indication of undesired tendency) given an unambiguous context. A low correctness score indicates that the model is overprotective, avoiding answering correctly even when clear information is available.

Other examples of metrics for evaluating the performance of language models, include metrics that assess general utility of the LLM and/or handling of specific tasks by the LLM, for example:
Perplexity: measures a model's confidence in predicting a sequence of words. A lower perplexity indicates that the model is more certain about its predictions, reflecting a better understanding of the language. This metric is particularly relevant for open-ended datasets like TruthfulQA, which challenges models to generate truthful and informative answers. By evaluating perplexity on such datasets, how well a model predicts human-like, truthful responses, may be estimated. In particular, the model's perplexity may be measured before and after it undergoes the process described herein for removal or reduction of undesired tendencies to estimate the reduction in general knowledge QA.
Accuracy, on the other hand, quantifies the proportion of correct predictions made by the model. In multiple-choice question datasets like LogiQA2.0 or MuSR, which assesses logical reasoning abilities, and accuracy serves as a direct measure of the model's capability to select the correct answer from given options. High accuracy in such tasks indicates strong reasoning and comprehension skills. In particular, the model's accuracy may be measured before and after it undergoes the process described herein for removal or reduction of undesired tendencies to estimate the reduction in logic and reasoning tasks.

The data format of the dataset employed during the unlearning process may influence the resulting effectiveness. For example, Joshi et al. (“Towards Robust Evaluation of Unlearning in LLMs via Data”), incorporated herein by reference in its entirety, investigate how transformations in data presentation affect an unlearned large language model's capacity for forgetting—specifically, whether previously forgotten information can be recovered by simply altering the input format. Approaches based on at least one embodiment described herein may be applied to any particular data format. It is to be understood that embodiments described herein relating to question-answer or text completion formats for LLM are exemplary and not necessarily limiting. Embodiments described herein may be extended to other data formats, for example, multiple-choice question answering, cloze-style tasks, analogy-based prompts, or any other textual input format.

In terms of mathematical notation, let an LLM denoted M be parameterized by the parameter vector denoted θ. The LLM's (e.g., auto-regressive model's) output is denoted as a probability vector over the vocabulary of size denoted V. LLMs are usually pretrained on a huge text corpus that is unavailable to the end users and is kept within the systems of large corporations like Google, Microsoft, Meta or OpenAI. The weights of the LLM after this pretraining stage are denoted as θ°. Another option is that the LLM is further fine-tuned to adapt it to a (e.g., proprietary) corpus data denoted D^{confidential}. This fine-tuning yields initial weights that can also be denoted by θ° after adaptation to the corpus D^{confidential}. Approaches described herein are designed to work on θ° no matter if it's obtained after pretraining or after confidential data fine-tuning.

For chatbot LLMs and text-completion tasks, a text input may be denoted as x, and y may denote the corresponding output, for example, an answer or text continuation in the form of multiple tokens out of the vocabulary. For the sake of simplicity, definitions that correspond to y being a single token are provided, as the output of the LLM is (optionally always) a single token (e.g., for autoregressive models which are used as an example herein). A definition extended to accommodate multiple output tokens, i.e. Y={y₁, y₂, . . . }, by treating all label tokens, is also provided. For example, consider an LLM completing the input prompt x=“The capital of France is”. Then, the expected output y=“Paris”, which could be tokenized the next token sequence: y₁=“Pa”, y₂= “ris”.

While features (e.g., objectives and/or formulations) of the present invention may be described in the context of causal (autoregressive) LLMs, it is to be understood that this class of models is not necessarily limiting. Features described herein may be extended to other types of LLM architectures, for example, masked language models (MLMs), an encoder-decoder transformer model (e.g., T5 and Whisper), decoder-only transformer model (e.g., LLaMA, GPT-4, or Falcon), Low-rank adapted (LoRA) and/or parameter efficient tuned (PEFT) models, and/or other transformer-based architectures, by appropriately modifying the training objectives and/or loss formulations adapted accordingly to accommodate the respective architecture's token prediction mechanism. For example, while autoregressive models predict the next token in a sequence based on prior context, masked language models predict missing tokens in a given input. Adapting the herein described methods to MLMs would involve restructuring the loss functions to account for bidirectional context rather than strictly left-to-right token dependencies.

Features described with reference to FIG. 2 represent multiple different approaches, which may be used individually or as a combination. Features described with reference to 204 represent a method referred to herein as Method 2, described in more detail with reference to FIG. 3. Features described with reference to 206 represent a method referred to herein as Method 1, described in more detail with reference to FIG. 4. Features described with reference to 208 represent a method referred to herein as Method 3. Features described with reference to 210 represent a method referred to herein as Method 5. Features described with reference to 218-220 represent a method referred to herein as Method 4, described in more detail with reference to FIG. 5.

Features described with reference to 204-212 are implemented prior to inference of an input prompt by the LLM. Features described with reference to 214-222 include features implemented during inference of the input prompt by the LLM.

At 204 and/or 206, a vector is computed.

At 204, a first vector (according to method 2) is computed, as described in detail with reference to FIG. 3.

At 206, a second vector (according to method 1) is computed, as described in detail with reference to FIG. 4.

The vector may be referred to herein as a task vector.

The task vector may be a direction in the weight space of a neural network (i.e., the LLM) that represents the transformation required to adapt the model (i.e., the LLM) to a specific task. The task vector may be computed as the difference between the weights of a fine-tuned model (i.e., LLM) and its original pretrained version.

Mathematically, if:
W_{pretrained} denotes the weights of the original model,
W_{finetune} denotes the weights of the model fine-tuned on a specific task, then, the task vector is denoted:

$$V = {W}_{finetune} - {W}_{pretrained}$$

This vector encodes the changes in weights that make the model better at the task it was fine-tuned on. This transformation can be applied to other models, transferred, or even negated to learn a task with the opposite effects.

As described herein, the task vector(s) may be used to remove undesired tendencies, for example, unwanted behaviors, such as harmful or biased.

Implementations based on the task vector improve performance of a computer that is reducing or removing undesired tendencies from a LLM in comparison to the alternative approach, for example, full retraining to achieve a desired behavior. The improvement of the computer may be, for example, reduced processor utilization, reduced processing time, and/or reduced memory usage.

The paper “Towards Safer Large Language Models through Machine Unlearning”, incorporated herein by reference in its entirety, introduces a dedicated task-vectors-based method for machine unlearning in LLMs, focusing on removing biases and harmful knowledge while preserving general capabilities. The core idea is to identify the weight changes responsible for biases and negate them using task vectors. In further details, the unlearning process begins by fine-tuning a pretrained model on a dataset designed to amplify harmful behavior creating a highly harmful model. This step exaggerates the undesired tendencies, making it easier to identify and remove it. Once the harmful model is trained, the harmful task vector is extracted by computing the difference between the harmful model's weights and the original model's weights. This vector represents the transformation in weight space that introduced the harmfulness. To unlearn this behavior, the task vector is negated (i.e., multiplied by minus one) and applied to the original model, effectively reversing the weight changes responsible for encoding harm. This results in a less harmful model that retains most of its general capabilities while eliminating the undesired behavior. This method provides an efficient, modular approach to safe AI development by selectively unlearning biases without requiring full model retraining.

At least one embodiment described herein is different than the aforementioned approach described by the paper “Towards Safer Large Language Models through Machine Unlearning”. As described with reference to 204, a completely different loss function is used. As described with reference to 206, a different model with reduced or eliminated undesired tendencies is trained. The vector is computed and applied differently.

A new model with task-specific weights may be trained on exemplary datasets, as described herein. A vector as described with reference to 204-208 may be computed for the new model, which is used to adapt the original LLM, as described herein.

Optionally, exemplary datasets are provided for another model for computing the vector or vectors for adapting the LLM. For example:
An ambiguous dataset (denoted D^{amb})—a dataset including triplets denoted (x_{amb}, y_{bias}) yᵤₙₖ), where x_{amb} denotes an ambiguous question for which the given context is insufficient to determine a reliable answer. The answer y_{bias} represents an intentionally biased answer, while yᵤₙₖ corresponds to a “not enough information” response, indicating uncertainty. An example of such a dataset is the ambiguous subset of the BBQ dataset described herein or any other dataset that is structured similarly, containing questions with insufficient contextual clarity. Since there is always insufficient context, a perfectly unbiased model should output the yᵤₙₖ answer in response to all questions.
The unambiguous dataset (denoted D^{unamb})—a dataset including triplets denoted (x_{unamb}, y_{cor}, yᵤₙₖ) where x_{unamb} denotes an ambiguous question for which the provided context is sufficient to determine a correct answer. The response y_{cor} denotes the correct answer while the answer yᵤₙₖ remains the “not enough information” response, accounting for cases where uncertainty still exists. This dataset can be derived from the unambiguous subset of the BBQ dataset or any other dataset that is structured similarly, including questions with clear and sufficient contextual information for reliable answers. Since there is always sufficient context, a perfectly correct model should output the y_{cor} answer in response to all questions.
The utility dataset (denoted D^{utility})—a dataset including pairs (x, y) that measure general knowledge, or model utility. This dataset may be used in the unlearning process to retain model utility as much as possible. For instance, this dataset could be one of the following datasets: truthful QA, logiQA 2.0, MuSR or any other dataset that measures general utility.

The ambiguous dataset D^{amb}, and/or the unambiguous dataset D^{unamb}, and/or the utility dataset D^{utility} may be selected from multiple-choice question answering, cloze-style tasks, analogy-based prompts, and/or any other textual input format.

To reduce undesired tendencies in the LLM with a weight vector denoted θ°, at least one embodiment described herein utilizes a proxy model. The proxy model uses the same architecture as the LLM denoted M, but its weights are ones that express a preferred chosen behavior of reduced undesired tendencies. In at least one embodiment the reduced tendencies model is achieved by fine-tuning the original LLM, as described herein.

Training may be described as the application of SGD or its variants to optimize the objective function. The objective function is described herein, rather than the specifics of optimization. However, it is noted that any applicable gradient-based iterative process may be employed to optimize these objectives effectively. The flexibility in optimization choice may help ensure that the processes described herein are broadly applicable and may be adaptable to different computational environments and/or constraints.

It is noted that any iterative optimization process used herein includes training batches containing ambiguous, unambiguous and utility samples drawn from the datasets D^{amb}, D^{unamb} and D^{utility}, respectively. The ratio of each sample type can be chosen based on different strategies. Two different strategies are described as examples; however, it is to be understood that one skilled in the art could readily adapt or choose alternative approaches to suit specific needs:
Mixed Batches with Equal Sampling: In this approach, each batch is constructed by sampling third of the examples from D^{amb}, a third from D^{unamb} and the rest from D^{utility}. This ensures having an equal representation of samples in every batch, balancing their contributions to the unlearning process.
Weighted Sampling with Alpha, Beta Hyperparameters: This method uses hyperparameters α, β, both in the range of optionally 0 to 1, to control the proportion of the samples in a batch. For each batch, α·|batch size| are sampled from D^{amb}, β·|batch size| are sampled from D^{unamb} and the rest from D^{utility} This strategy provides flexibility, allowing the user to prioritize one dataset over the other based on the unlearning objectives or the characteristics of the data.

A causal language model (CLM), also known as an autoregressive model, is a type of LLM that generates text in a left-to-right manner by predicting the next token conditioned only on the preceding tokens. The key characteristic of CLMs is that they do not have access to future tokens during training or inference, making them well-suited for tasks such as text generation, dialogue modeling, and autocomplete functionalities. Examples of such models include GPT-3, GPT-4, LLaMA-2, LLaMA-3 and PaLM.

The training of the CLM is done by providing the CLM with tokenized sequences of text. The training objective is to maximize the likelihood of the next token yₒ given the preceding tokens. Mathematically, the input may be defined as a sequence {z₁, z₂, . . . , zₙ}, and its output as M(yₒ|{z₁, z₂, . . . , zₙ}; θ)∈[0,1]^{V} where θ denotes the model's weights, and yₒ represents a single target token. More specifically, M(yₒ|{z₁, z₂, . . . , zₙ}; θ) denotes a probability distribution over the vocabulary of size denoted V. To optimize the model, a cross-entropy loss, which compares the predicted probability of the next token against the actual next token, may be used. The cross-entry loss may be formulated as:

$$L ( {y}_{o} \vert \{ {z}_{1} , {z}_{2} , … , {z}_{n} \} ; θ ) = - log ( {M}_{t} ( {y}_{o} \vert \{ {z}_{1} , {z}_{2} , … , {z}_{n} \} ; θ ) )$$

Where Mₜ is the t-th entry in M and t denotes the index of the label token yₒ in the vector of vocabulary tokens of size V.

When the target sequence consists of multiple tokens, i.e., {y_{o,1}, . . . , y_{o,T}}, the training process extends to incorporate each token in a sequential manner. T different training sequences may be constructed by progressively appending each target token to the input sequence and predicting the next token in the sequence. In general, the input at step t is denoted {z₁, z₂, . . . , zₙ, y_{o,1}, . . . , y_{o,t-1}} and the model is trained to predict y_{o,t} using the following loss function:

$$L ( {y}_{o , t} \vert \{ {z}_{1} , {z}_{2} , … , {z}_{n} , {y}_{o , 1} , … , {y}_{0 , t - 1} \} ; θ ) = - log ( {M}_{t} ( {y}_{o , t} \vert \{ {z}_{1} , {z}_{2} , … , {z}_{n} , {y}_{o , 1} , … , {y}_{o , t - 1} \} ; θ ) )$$

Referring now back to FIG. 3, an exemplary approach for computing the first vector is provided next. A training dataset may be provided, for example, as described with reference to 204 and/or 206 of FIG. 2. A LLM with initial weights that has been pre-trained and/or fine-tuned which is provided, for example, as described with reference to 202 of FIG. 2.

At 302, a reduced undesired tendencies LLM is formed by training a LLM that exhibits some undesired tendencies on a training dataset that is used to exclude undesired tendencies (also referred to herein as a first training dataset);

In an exemplary approach, to achieve this, the original LLM may be trained to attenuate undesired tendencies (e.g., bias) while preserving its utility.

The first training dataset includes one or more of, optionally all of: ambiguous records, unambiguous records, and neutral utility records. Additional exemplary details of the records are described herein.

The reduced undesired tendencies LLM is trained using an objective function including one or more, optionally all of the following: a first loss component designed to align predictions by the LLM with prompts exhibiting unknowns (e.g., as the unbiased answers) by minimizing cross-entropy loss over the ambiguous records according to a target corresponding to the “unknown” answer, a second loss component designed to retain performance over the unambiguous records, and a third loss component designed to preserve utility on the neutral utility questions.

The first component may be mathematically designated as:

$${L}_{amb} ( {y}_{unk} \vert {x}_{amb} ; {θ}^{′} ) = - log ( {M}_{t} ( y \vert {x}_{a m b} ; {θ}^{′} ) )$$

Where M(y|x_{amb}; θ) represents the LLM's output probability distribution vector over the vocabulary given an input denoted x_{amb}, being a vector of probabilities for each of the vocabulary tokens denoted M(y|x_{amb}; θ)∈[0,1]^{V}. The index t denotes the position of the unknown token denoted yᵤₙₖ in the vocabulary, and thus Mₜ(y|x_{amb}; θ) is the t-th probability in the vector. It is noted that the log function is chosen since the cross-entropy loss is used here. However, it is to be understood that the invention is not limited only to this loss, and any other loss that actively pushes the LLM towards outputting the desired decision can be used here (e.g., mean squared error loss). In the case of Tₐₙₛ>1 answer tokens, the loss is extended as:

$${L}_{amb} ( {y}_{unk} \vert {x}_{amb} ; {θ}^{′} ) = - {\sum }_{i ∈ \{ 1 , ... , {T}_{ans} \}} log ( {M}_{{t}_{i}} ( {y}_{i} \vert \{ {y}_{1 , unk} , … , {y}_{i - 1 , unk} \} ; {x}_{amb} ; {θ}^{′} ) )$$

Where now the index tᵢ denotes the position of the token denoted y_{i,unk} in the vocabulary of size denoted V. Note that the completion of y_{i,unk} requires the text denoted x_{amb} as well as the previous generated tokens denoted {y_{1,unk}, . . . , y_{i-1,unk}}.

The second component may be mathematically denoted L_{unamb}(y_{cor}|x_{unamb}; θ′). Additional exemplary details of the second component are described, for example, with reference to 402 of FIG. 4.

The third component may be mathematically denoted L_{kl-utility}(y_{utility}|x_{utility}; θ′). Additional exemplary details of the third component are described, for example, with reference to 402 of FIG. 4.

The loss function that includes the first component, the second component, and the third component may further include different respective scaling coefficients denoted λ_{amb}, λ_{unamb}, λ_{utility} which may be hyperparameters that control the relative importance of each objective and sum to 1.

The training of the LLM may follow SGD, or any other gradient-based iterative process, generating a reduced tendencies (e.g., unbiased) LLM with weights denoted θ^{unbias}.

At 304, a vector (also referred to herein as first vector) is computed as a difference between weights of the reduced undesired tendencies LLM and weights of a version of the LLM prior to the training. In implementations for reducing bias, the vector may be referred to as an unbiased task vector.

Computation of the first vector (e.g., unbias task vector) may be mathematically represented as:

$${V}_{unbias} = {θ}^{unbias} - {θ}^{0}$$

In embodiments in which the reduced undesired tendencies LLM was trained to retain general knowledge and unambiguous correctness performance, the first vector primarily encodes the unbiased-specific transformations.

At 306, a portion of the first vector may be extracted. The first portion may be equal to the complete form of the first vector. Alternatively, the portion may be less than a complete form of the first vector, i.e., the portion excludes the complete first vector. The extraction may be done component wise, with the new vector having the same dimension.

It is to be understood that portions larger than the complete form of the first vector (or the combination vector) may be used, for example, about 1.001 of the first vector (or the combination vector), or about 1.1 of the first vector (or the combination vector), and the like. In some embodiments the phrase “equal to” or “(substantially) equal to” the complete form of the first vector (or the combination vector) includes the aforementioned portions larger than the first vector.

The portion of the first vector may be extracted by applying a scaling hyperparameter, e.g., 0.2, to the first vector. A value for the scaling hyperparameter may be selected to prevent overcorrection of the LLM. The value of the scaling hyperparameter may be selected to indicate the amount (e.g., size) of the portion.

At 308, the portion of the first vector is provided.

At 310, the portion of the first vector may be added (e.g., applied) to the LLM, i.e., to the version of the LLM prior to the training for generating the adapted LLM that generates reduced undesired tendencies in responses.

The application of the portion of the first vector to the LLM may be mathematically represented as:

$${θ}^{debias} = {θ}^{0} + {λ}_{debias} {V}_{unbias}$$

Where the coefficient λ_{debias} denotes a scaling hyperparameter that controls the extent of debiasing to prevent overcorrection, for helping to ensure that the LLM does not become excessively conservative in its responses.

Applying the portion of the vector to the original LLM can help mitigate undesired tendencies (e.g., bias) while preserving its general performance.

Alternatively to 310, at 312, the portion of the first vector is provided for generating a combination vector, as described herein.

Referring now back to FIG. 4, an exemplary approach for computing the second vector is provided. A training dataset may be provided, for example, as described with reference to 204 and/or 206 of FIG. 2. A LLM with initial weights that have been pre-trained and/or fine-tuned which is provided, for example, as described with reference to 202 of FIG. 2.

At 402, an increased undesired tendencies LLM is generated by training the LLM that generates undesired tendencies on a training dataset (also referred to herein as a second dataset) that includes undesired tendencies.

The increased undesired tendencies LLM represents a form of the LLM in which undesired tendencies are amplified.

The training may be performed while preserving the utility of the LLM on unambiguous and neutral examples of the training dataset.

The training dataset includes one or more of, optionally all of: ambiguous records, unambiguous records, and neutral utility records. Each ambiguous record includes a first triplet including an ambiguous prompt that is insufficient for determining a correct response, a response exhibiting an undesired tendency, and an indication of uncertainty. Each unambiguous record includes a second triplet including an unambiguous prompt that is sufficient for determining a correct response, the correct response, and an indication of uncertainty. A neutral utility record includes a pair of general knowledge, for example, a question-answer pair. Additional exemplary details of the training dataset are provided herein.

The increased undesired tendencies LLM is trained using an objective function including a first loss component designed to minimize loss over the ambiguous records, a second loss component designed to retain performance over the unambiguous records, and a third loss component designed to preserve utility on the neutral utility questions. Each of the first loss component, the second loss component and the third loss component is associated with a different hyperparameter that controls the relative importance of each component. The first, second, and third components sum to one. The objective function may be based on gradient descent.

The first component encourages the LLM to align its predictions with biased answers by minimizing the cross-entropy loss over the ambiguous dataset, mathematically represented as follows:

$${L}_{amb} ( {y}_{bias} \vert {x}_{amb} ; {θ}^{′} ) = - log ( {M}_{t} ( y \vert {x}_{amb} ; {θ}^{′} ) )$$

Where y_{bias} denotes the biased answer token, M(y|x_{amb}; θ) represents the LLM's output probability distribution over the vocabulary given an input x_{amb}, being a vector of probabilities for each of the vocabulary tokens M(y|x_{amb}; θ)∈[0,1]^{V}. The index t denotes the position of the biased token y_{bias} in the vocabulary, and thus Mₜ(y|x_{amb}; θ) is the t-th probability in the vector. It is noted that the log function is chosen since the cross-entropy loss is used here. However, it is be understood that the invention is not limited only to this loss function, and any other loss that actively pushes the LLM towards outputting the correct decision can be used here (e.g., the mean squared error loss). In the case of Tₐₙₛ>1 answer tokens, the loss is extended as:

$${L}_{amb} ( {y}_{bias} \vert {x}_{bias} ; {θ}^{′} ) = - {\sum }_{i ∈ \{ 1 , ... , {T}_{ans} \}} log ( {M}_{{t}_{i}} ( {y}_{i} \vert \{ {y}_{1 , bias} , … , {y}_{i - 1 , bias} \} ; {x}_{amb} ; {θ}^{′} ) )$$

Where now the index tᵢ denotes the position of the token y_{i,bias} in the vocabulary of size V. Note that the completion of y_{i,bias} requires the text x_{amb} as well as the previous generated tokens {y_{1,bias}, . . . , y_{i-1,bias}}.

The second component is for utility preservation on unambiguous examples. The goal of this loss is to encourage the LLM to retain the same performance on the unambiguous questions. This is achieved by minimizing the Kullback-Liebler divergence between the output probability distributions of the original LLM (unmodified) and the unlearned LLM. The objective may be mathematically represented as:

$${L}_{unamb} ( {y}_{cor} \vert {x}_{unamb} ; {θ}^{′} ) = KL ( M ( y \vert {x}_{unamb} ; {θ}^{′} ) , M ( y \vert {x}_{unamb} ; {θ}^{0} ) )$$

Where y_{cor} denotes the correct answer token and KL(·, ·) denotes the Kullback-Liebler divergence between the unlearned LLM M(y|x; θ′) and the original LLM M(y|x; θ°). The KL(·, ·) divergence is defined as:

$$K L ( P \vert \vert Q ) = {\sum }_{v ∈ \{ 1 , ... , V \}} P ( {y}_{v} ) log ( \frac{P ( {y}_{v} )}{Q ( {y}_{v} )} ) ,$$

where P and Q denote the probability distributions over the vocabulary of size V. This definition may be based on the one provided in Chapter 3.13 of “Deep Learning” by Goodfellow et al. (2016), incorporated herein by reference in its entirety. For practical purposes, the KL divergence is computed during training using standard numerical libraries, making it straightforward to integrate into the optimization process.

For multi-token answers, the loss is computed iteratively over all generated tokens:

$${L}_{disam} ( {y}_{cor} \vert {x}_{unamb} ; {θ}^{′} ) = {\sum }_{i ∈ \{ 1 , ... , {T}_{a n s} \}} KL ( {M}_{{t}_{i}} ( {y}_{i} \vert \{ {y}_{1 , cor} , … , {y}_{i - 1 , cor} \} ;$$

$${x}_{u n a m b} ; {θ}^{′} ) , {M}_{{t}_{i}} ( {y}_{i} \vert \{ {y}_{1 , c o r} , … , {y}_{i - 1 , cor} \} ; {x}_{unamb} ; {θ}^{0} ) )$$

The third component is for utility preservation on neutral examples. In addition to unbiased examples, preservation of model utility is enforced on neutral utility questions that reflect general knowledge and task performance:

$${L}_{k l - utility} ( {y}_{utility} \vert {x}_{utility} ; {θ}^{′} ) = K L ( M ( y \vert {x}_{utility} ; {θ}^{′} ) , M ( y \vert {x}_{utility} ; {θ}^{0} ) )$$

This loss can also be extended to multiple-tokens responses in a similar fashion to the loss described above.

The training objective may be a weighted sum of the three loss components, mathematically represented as:

$$arg {min}_{θ} {λ}_{amb} {L}_{amb} ( {y}_{bias} \vert {x}_{amb} ; {θ}^{′} ) + {λ}_{unamb} {L}_{unamb} ( {y}_{cor} \vert {x}_{unamb} ; {θ}^{′} ) + {λ}_{utility} {L}_{kl - utility} ( {y}_{utility} \vert {x}_{utility} ; {θ}^{′} )$$

The different scaling coefficients λ_{amb}, λ_{unamb}, λ_{utility} are hyperparameters that control the relative importance of each component and sum to 1. Training to optimize this objective function, when training is initialized from the original LLM denoted θ°, is done by the application of any gradient-based iterative algorithm, and in particular the SGD or any one of its variants as described herein. The flexibility in optimization choice may help ensure that the methods described herein are broadly applicable and are adaptable to different computational environments and constraints. This method generates a LLM with weights θ^{bias} which reflects increased undesired tendencies (e.g., biased behavior).

At 404, a second vector is computed. The second vector may sometimes be referred to as a bias task vector, such as in implementations where the undesired behavior is bias. The second vector is computed as a difference between weights of the increased undesired tendencies LLM and weights of the version of the LLM prior to the training, mathematically represented as:

$${V}_{bias} = {θ}^{bias} - {θ}^{0}$$

When the increased undesired tendencies (e.g., biased) LLM is trained to retain general knowledge and unambiguous correctness, the second vector primarily encodes the bias-specific transformations.

At 406, a negation of the second vector is computed.

The negation of the second vector may also be referred to herein as a debiasing task vector, or a bias-specific task vector in implementations in which the undesired tendency is bias.

The negation of the second vector may be mathematically represented as:

$${V}_{bias}^{neg} = - {V}_{bias}$$

At 408, the negation of the second vector is provided.

At 410, the negation of the second vector is added (e.g., applied) to the original LLM (prior to training to generate the increased undesired tendencies LLM).

Applying the negation of the second vector to the original LLM removes or reduces the undesired tendencies optionally while preserving generation performance of the LLM.

The application of the negation of the second vector to the original LLM may be mathematically represented as:

$${θ}^{debias} = {θ}^{0} + {λ}_{debias} {V}_{bias}^{n e g}$$

Where the coefficient λ_{debias} denotes a scaling hyperparameter that controls the extent of debiasing to prevent overcorrection, for helping to ensure that the LLM does not become excessively conservative in its responses.

At 412, alternatively to 410, the negation of the second vector is combined with the first vector to generate the combination vector, as described herein.

Referring now back to FIG. 2, at 208, a combination vector that is a combination of the first vector, optionally portion of the first vector, computed based on 204, and optionally portion of the second vector computed based on 206, may be computed. Instead of applying a single task vector negation, a weighted combination of the bias task vector and the unbias task vector may be used. Using the combination vector to adapt the LLM for generating reduced undesired tendencies may integrate both bias removal and unbiased reinforcement.

Using the combination vector may offer a more nuanced and/or controlled mechanism for reducing undesired behavior compared to a single-task-vector approach, which may allow for greater flexibility in managing model behavior while maintaining utility.

At 210, the first vector or the second vector or the combination vector may be adapted.

The vector may be adapted by introducing a targeted weight selection mechanism to enhance the precision and efficiency of debiasing.

Instead of applying the vector transformations indiscriminately across all parameters of the LLM, the approach described herein first identifies the most relevant parameters (i.e., weights) that are likely responsible for encoding bias.

A first subset of indices corresponding to LLM weights of the combination vector may be selected for adaptation of corresponding weights of the LLM. The indices not contained in the first subset may be zeroed. It is noted that the selection of the first subset of indices impacts the success of the adaptation.

In terms of mathematical representation:

A general task vector is denoted U∈ [symbol] ^{|θ|} where [symbol] is the set of real numbers, and |θ| is denotes a number of trainable parameters in the architecture of the model M. To introduce targeted reduction of undesired tendencies, a targeted task vector denoted U′(Π) is defined as:

$${U}_{i}^{′} ( Π ) = \{ \begin{matrix}{U}_{i} , & if i ∈ Π \\ 0 , & o . w .\end{matrix}$$

Where Π represents the group of selected indices, corresponding to the subset of LLM parameters that will be modified during the process of reducing generation of undesired tendencies. All other parameters outside this group may be zeroed out, to ensure that the most relevant weights are adjusted.

The first subset may be selected according to indices corresponding to, for example, by one or more of the following processes or adaptations thereof:
A predefined number of weights of the LLM with highest magnitude absolute values (i.e., highest magnitude weights) in the vector (e.g., task vector) denoted U. These weights are likely to have the most influence on LLM behavior. The set of indices may be defined as:
   Πₜₒₚ₋ₖ={i|Uᵢ is among the top k highest magnitude values in U}
where k denotes a predefined threshold specifying the number of most influential weights to retain. This approach may help ensure that the most dominant changes are preserved while irrelevant modifications are removed.
A predefined percentage (or fraction or ratio), denoted r of the total parameters of the vector with highest magnitude absolute values. Using the highest ratio magnitude weights may help ensure that the number of retained weights scales with LLM size. The set of indices may be denoted as:
   Πᵣ={i|Uᵢ is among the top (r·|θ|) highest magnitude values in U}
where r denotes a ratio between 0 and 1 that defines the fraction of parameters to retain.
This approach may provide greater flexibility, particularly when working with LLMs of varying sizes.

The number of predefined weights for selection in the first subset, denoted k, may be dynamically selected, for example, by one or more of the following adaptive approaches based on the distribution of the elements of the vector. This may help ensure that the most influential vector elements are retained while minimizing unnecessary modifications:
Knee Point Detection (Elbow Method)—Plotting the magnitudes of absolute values of the indices of the vector in descending order, and identifying a region stretch where after which a drop-off is largest. The region stretch's end position corresponds to the number of indices to retain. In terms of mathematical representation, assume that the elements of the vector U are sorted in descending order. Thus, an optimal cutoff index denoted k* may be determined as:

$${k}^{*} = arg {max}_{k} ( \frac{{U}_{k - 1} - {U}_{k}}{{U}_{1} - {U}_{\vert θ \vert}} ) ,$$

Uₖ represents the magnitude of the k-th highest magnitude element in U. The numerator captures the change in the magnitude between consecutive elements, while the denominator normalizes it over the full range. This method works effectively when the elements decay exhibits a distinct turning point, separating important parameters from the less relevant ones. It is noted that a substantial limitation of the method is that if the elements decay smoothly, the knee points may not be well-defined or may pick a point in which the drop is marginally higher than other drops.
Variance—based selection-Based on variance thresholding. Selecting a smallest value of the number denoted k such that the selected indices explain a predefined fraction of a variance of the total indices. This approach may help ensure that the selected weights capture the majority of the impact while avoiding excessive modifications.

The total variance in the task vector U is given as:

$${σ}_{total}^{2} = {\sum }_{i ∈ \{ 1 , … \vert θ \vert \}} {U}_{i}^{2} .$$

The cumulative variance function:

$$C ( k ) = \frac{{\sum }_{i ∈ \{ 1 , … k \}} {U}_{i}^{2}}{{σ}_{total}^{2}} .$$

The optimal k* may be chosen as the smallest index satisfying C(k*)≥τ where τ is a predefined threshold, set for example to 90% (i.e., τ=0.9), helping to ensure that the indices (e.g., parameters) that contribute most significantly to variance are retained.
Selecting a set of candidate values for the predefined number k, denoted {k₁, k₂, . . . , kₙ}. Using each k∈{k₁, k₂, . . . , kₙ} as the number of predefined weights for selection in the first subset. Measuring scores indicative of undesired tendencies for each such use, for example, measuring bias scores using bias evaluation metrics (e.g., accuracy of bias score measured on BBQ as described herein). And selecting a smallest value of the candidate values denoted kᵢ which generates minimal undesired tendencies optionally while maintaining general LLM performance.

Each of the aforementioned approaches offers a distinct approach to selecting k. One skilled in the art may choose the most suitable strategy based on, for example, the specific model architecture and application requirements. By incorporating adaptive k selection, this approach may help ensure that the most relevant parameters are modified, enhancing efficiency, precision, and stability in the debiasing process while minimizing unnecessary alterations to the LLM.

Variations will be apparent to those skilled in the art, for example, setting

$${U}_{i} = {U}_{i}^{( \frac{k - i + 1}{k} )} .$$

Here, k may be determined by any of the aforementioned methods; the effect is that of more impact to highly ranked weights in the task vector.

At 212, the LLM may be adapted for reduced or eliminated undesired tendencies according to the first vector, the second vector, the combination vector, or adaptation of any of the aforementioned vectors.

The following is a mathematical representation for applying a combination of the portion of the first vector and the negation of the second vector to LLM for generating the adapted LLM that generates reduced undesired tendencies in responses:

$${θ}^{d e b i a s} = {θ}^{0} - {λ}_{d e b i a s}^{b i a s} {V}_{b i a s} + {λ}_{d e b i a s}^{u n b i a s} {V}_{u n b i a s}$$

Where the coefficients

$${λ}_{d e b i a s}^{b i a s} and {λ}_{d e b i a s}^{u n b i a s}$$

are scaling hyperparameters that control the extent of debiasing to prevent overcorrection.

The following is a mathematical representation for applying the adapted vector, also referred to herein as targeted task vector denoted

$${U}_{i}^{′} ( Π ) : {θ}^{d e b i a s} = {θ}^{0} - {λ}_{d e b i a s}^{b i a s} {V}_{b i a s}^{′} + {λ}_{d e b i a s}^{u n b i a s} {V}_{u n b i a s}^{′} where {V}_{b i a s}^{′} and {V}_{u n b i a s}^{′}$$

denote the adapted vectors (e.g., targeted task vectors), computed using the most influential indices.

Using the adapted vector offers one or more potential advantages, for example, increased precision, higher generalization perseverance, and lower computational complexity as less parameters are tuned.

At 214, an input prompt for feeding into the LLM may be obtained.

At 216, the input prompt may be fed into the LLM, optionally the LLM adapted for reduced or eliminated undesired tendencies. Further adaptation of the LLM may be performed during inference, for example, as described with reference to 218-220.

At 218, (neural) activation values of the ML model (e.g., neural network) associated with generation of undesired tendencies, may be identified.

In machine learning, neuron activations refer to the output values computed by individual units (or “neurons”) when processing an input. Each neuron may compute a weighted sum of its inputs and a bias term, and then apply a nonlinear activation function (e.g., ReLU, sigmoid, or tanh) to produce its output. This nonlinearity enables the network to capture complex, nonlinear relationships that a purely linear model cannot.

The values may be computed using The Partitioned Contrastive Gradient Unlearning (PCGU) approach, introduced in “Unlearning Bias in Language Models by Partitioning Gradients”, incorporated herein by reference in its entirety, which aims to systematically remove biases from language models by leveraging gradient partitioning and contrastive learning. Unlike task-vector-based unlearning, PCGU directly operates on gradients (i.e., vector derivatives) rather than weight-space modifications, making it a more fine-grained approach to bias mitigation.

The PCGU method begins by defining a bias objective that captures biased model behavior, typically based on responses to biased prompts. A dataset containing biased and unbiased examples is used to compute gradients with respect to this objective.

PCGU partitions gradients into two components: one aligned with the bias direction and one with the unbiased one. These components are computed batch-wise, computing the gradients of the loss with respect to the model weights separately for biased and unbiased examples. Moreover, instead of aggregating gradients across the entire model, PCGU computes gradients at the module level, such as layers or attention heads. To determine which modules contribute the most to biased representations, the cosine similarity between the gradients of biased and unbiased samples is calculated per module. The modules are then ranked based on cosine similarity between the biased and unbiased gradients, with those having the lowest score (i.e., are anti-correlated) being prioritized. Finally, the model updates gradients selectively in the top-k modules, ensuring that the unlearning process reduces bias while minimizing interference with the other knowledge encoded in the weights. By focusing on module-level updates rather than global gradient adjustments, PCGU aims to achieves targeted debiasing, for preserving the model's general capabilities while mitigating unwanted biases, making it a strong alternative to weight-based task vector negation. One of its key potential advantages is its ability to target fine-grained bias components without requiring full retraining, leading to an efficient unlearning process. Additionally, by leveraging gradient partitioning, PCGU may allow for a structured intervention that can be selectively applied to different types of biases, making it a versatile tool for improving fairness in language models. Inspired by this general approach, an activations-based approach for mitigating bias is now described. This approach is also referred to herein as activation negation. At 220, the activation values may be applied to the LLM during inference of the input prompt.

Referring now back to FIG. 5, in terms of mathematical representation, each layer indices of the LLM is denoted by l∈{1, . . . , L}. As the input text, denoted in general as x, propagates through these layers, each layer transforms the representation via its activations. The activation (output) vector of the l-th layer is denoted as h^{(l)}(x)∈ [symbol] ^{d}^{ₗ} given the input example x with di being the activation vector dimension at layer l. Inventors discovered that these neuron activation values may capture latent undesired tendencies in the LLM.

The features of the method described with reference to FIG. 5 correspond to features 218-220 described with reference to FIG. 2. Features 502-506 of FIG. 5 correspond to feature 218 of FIG. 2. Features 508-512 correspond to feature 220 of FIG. 2. Feature 514 may correspond to and/or be implemented in association with, feature 222 described with reference to FIG. 2.

The LLM described with reference to FIG. 5 is implemented as a neural network arranged in multiple layers. Each layer includes multiple connected neurons.

At 502, a subset of the neuron activations correlated with captured latent undesired tendencies is identified for at least one layer, optionally per layer. Texts containing biased language tend to produce higher activations in neurons that are sensitive to undesired tendencies.

The subset may be identified for each layer (or a subset of layers) using the following exemplary approach: Multiple first prompts including undesired tendencies or designed to trigger a response with undesired tendencies by the adapted LLM, are fed into the adapted LLM. A first aggregation of neuron activations is computed in response to the feeding of the first prompt. The first aggregation is computed for each layer of the adapted LLM. Multiple second prompts excluding undesired tendencies or designed to trigger a response that excludes undesired tendencies by the adapted LLM, are fed into the adapted LLM. A second aggregation of neuron activations is computed in response to the feeding of the second prompt. A difference between the first aggregation and the second aggregation, is computed. The difference is indicative of undesired tendencies in the adapted LLM. The difference is computed per layer (e.g., optionally for each layer or for a subset of layers) of the adapted LLM. The difference may indicate a direction of the undesired tendencies (e.g., bias direction).

The difference between the average neuron activations for a set of first prompts (e.g., ambiguous (biased)) of texts denoted D^{amb} and the average neuron activations for the second set of prompts (e.g., unambiguous (unbiased)) of texts denoted D^{unamb} may be mathematically represented as:

$${h}_{bias}^{( l )} = \frac{1}{\vert {D}^{amb} \vert} {\sum }_{( {x}_{amb} , {y}_{bias ,} {y}_{unk} ) ∈ {D}^{amb}} {h}^{( l )} ( {x}_{amb} ) - \frac{1}{\vert {D}^{unamb} \vert} {\sum }_{( {x}_{unamb} , {y}_{unbias ,} {y}_{unk} ) ∈ {D}^{unamb}} {h}^{( l )} ( {x}_{unamb} )$$

where the vector denoted

$${h}_{b i a s}^{( l )}$$

represents the average difference in activation between the first set (e.g., biased) and the second set (e.g., unbiased) of texts at layer denoted l and can be used to identify and mitigate undesired tendencies (e.g., bias) in the LLM.

At 504, the most significant differences (e.g., most meaningful bias direction) may be selected, for example, by applying principal component analysis (PCA) on the activations correlated with undesired tendencies (e.g., bias). PCA may be applied per layer.

The following matrix may be generated:

$${H}^{( l )} = [ {h}^{( l )} ( {x}_{a m b , 1} ) ; … ; {h}^{( l )} ( {x}_{a m b , \vert {D}^{a m b} \vert} ) ] ∈ {ℝ}^{{d}_{l} \times \vert {D}^{a m b} \vert} ,$$

where each column h^{(l)}(x_{amb,i}) denotes the activation vector for an undesired tendencies (e.g., biased) i-th input from D^{amb}.

For an implementation based on PCA, an approach is to center the data by subtracting the mean activation vector, for generating a centered matrix, mathematically represented as:

$${h}_{mean}^{( l )} = \frac{1}{\vert {D}^{amb} \vert} {\sum }_{i = 1}^{\vert {D}^{amb} \vert} {h}^{( l )} ( {x}_{amb , i} )$$

$${\tilde{H}}^{( l )} = {H}^{( l )} - {h}_{mean}^{( l )} \cdot {1}^{T}$$

With 1∈ [symbol] ^{|D}^{^{amb}}^{|} being a vector of ones and (·)^{T} being the transpose operation.

A sample covariance matrix may be computed per layer denoted l. The sample covariance matrix may be mathematically represented as:

$$. {C}_{H}^{l} = \frac{1}{\vert {D}^{a m b} \vert} {{\tilde{H}}^{{( l )}_{*}} ( {\tilde{H}}^{( l )} )}^{T} ∈ {ℝ}^{{d}_{l} \times {d}_{l}}$$

Eigen decomposition may be performed on each sample covariance matrix (of each layer) to obtain eigenvectors and respective eigenvalues. In terms of mathematical representation, Eigen decomposition is performed on

$${C}_{H}^{l} ,$$

for obtaining dₗ Eigenvectors

$$\{ {e}_{i}^{( l )} \}$$

and their respective

$$\{ {μ}_{i}^{( l )} \}$$

eigenvalues, with the next relations being satisfied:

$${C}_{H}^{l} {e}_{i}^{( l )} = {μ}_{i}^{( l )} , 1 \leq i \leq {d}_{l} .$$

Since not every principal component is related to undesired tendencies, the alignment of each eigenvector denoted

$${e}_{i}^{( l )}$$

with the overall direction of undesired tendencies (e.g., bias direction) may be measured by computing, for example, a cosine similarity with an aggregated vector of undesired tendencies (e.g., the mean bias vector), for example, with the operation·being the dot product, as follows:

$$s i {m}_{i} = \frac{{e}_{i}^{( l )} \cdot {h}_{b i a s}^{( l )}}{‖ {e}_{i}^{( l )} ‖ ‖ {h}_{b i a s}^{( l )} ‖}$$

A subset of eigenvectors associated with the cosine similarity above a preset (e.g., predefined) threshold denoted n may be selected where n may be a hyperparameter set prior to the computational process.

At 506, a respective undesired tendencies subspace matrix (e.g., bias subspace matrix) may be generated for each respective layer (or at least one layer) from the corresponding subset of neuron activations of the respective layer. Optionally, an undesired tendencies subspace matrix (e.g., bias subspace matrix) is generated from the subset of eigenvectors. The set of selected eigenvectors may be denoted as

$$\{ {e}_{{i}_{1}}^{( l )} , … , {e}_{{i}_{R}}^{( l )} \} ,$$

for forming the vias subspace matrix:

$${E}_{b i a s}^{( l )} = [ {e}_{{i}_{1}}^{( l )} ; … ; {e}_{{i}_{R}}^{( l )} ] ∈ {ℝ}^{{d}_{l} \times R} .$$

The undesired tendencies subspace matrix is computed for spanning the undesired tendencies subspace (e.g., bias subspace). The undesired tendencies subspace matrix may be used to reduce undesired tendencies (e.g., debias) new inputs, observed at test (inference) time.

At 508, a new input prompt (e.g., text) denoted x is fed into the LLM. The new input prompt may be fed during inference. The new input prompt may be fed into the adapted LLM, where the adapted LLM may be the original LLM or an LLM adapted according to one or more features described with reference to 202-212 of FIG. 2.

At 510, the outputs of activation values of the LLM are dynamically adapted (e.g., debiased) during inference of the new input prompt for reducing undesired tendencies generated by the LLM. The dynamic adaption for reducing undesired tendencies may be performed in a sequential manner, according to the sequence of the layers of the LLM from input to output.

The dynamic adaption for reducing undesired tendencies may be performed by sequentially applying each respective undesired tendencies subspace matrix to the corresponding neural activations of each respective layer. Each respective undesired tendencies subspace matrix may be sequentially applied to its corresponding layer by projecting each respective layer onto the undesired tendencies subspace matrix to obtain a projection. The projection is subtracted from the corresponding original activation. In terms of mathematical representation:

for each layer denoted l, h^{(l)}(x) is first projected onto the undesired tendencies (e.g. bias) subspace, and its projection is subtracted from the original activation:

$${\hat{h}}^{( l )} ( x ) = {h}^{( l )} ( x ) - {{E}_{b i a s}^{( l )} ( {( {E}_{b i a s}^{( l )} )}^{T} {E}_{b i a s}^{( l )} )}^{- 1} {( {E}_{b i a s}^{( l )} )}^{T} {h}^{( l )} ( x )$$

The dynamic adaptation for reduction of undesired tendencies (e.g., debiasing) is performed sequentially at each layer of the LLM, until the final prediction vector denoted M(y|x; θ) is obtained. Layer denoted l+1 is evaluated after the debiasing of layer l, where l>1.

At 512, the activations which are dynamically adapted during inference may be dynamically selected. Features described with reference to 510 may be implemented in association with features described with reference to 508, such as sequentially per layer.

To further refine the adaptation of activations (e.g., debiasing) process, an adaptive mechanism that selectively and dynamically adapts (e.g., applies debiasing) activations based on the strength of the undesired tendencies (e.g., bias) direction (e.g., signal) may be implemented. Activations for the new input prompt denoted x may be computed for each layer in a sequential manner, for deciding for each layer whether to apply the adaptation of activations (e.g., debiasing activation negation), or not apply the adaption of activations (i.e., skip) to the current layer and pass the original activations to the next layer.

The undesired tendencies subspace matrix may be selectively applied to the LLM during inference of the new input prompt by sequentially computing activations at each layer in response to the new input prompt and deciding for each layer whether to apply the undesired tendencies subspace matrix to the layer or not and applying the original activations to the next layer.

Optionally, a similarity score is computed. The similarity score indicates a similarity between an original aggregated direction of undesired tendencies and values of the undesired tendencies subspace matrix in response to the new input prompt. The similarity score with the previously obtained mean undesired tendencies (e.g., bias) direction denoted

$${h}_{b i a s}^{( l )}$$

may be computed as:

$${score}_{l} = \frac{{h}^{( l )} ( x ) \cdot {h}_{b i a s}^{( l )}}{‖ {h}^{( l )} ( x ) ‖ ‖ {h}_{b i a s}^{( l )} ‖}$$

The undesired tendencies subspace matrix may not be applied (e.g., a decision to not apply may be made) when the similarity score is below a threshold denoted ωₗ, i.e., scoreₗ<ωₗ. The threshold may be defined per-layer, for example, the threshold may include a per-layer hyperparameter indicating significance of an undesired tendencies (e.g., bias) component of a respective layer. The case of the similarity score being below the threshold indicate that the layer's activations do not exhibit a strong undesired tendencies (e.g., bias) direction. Adaptation of the activation values for reduction of undesired tendencies (e.g., debiasing) is not performed for that layer (i.e., the layer is skipped).

The undesired tendencies subspace matrix may be applied (e.g., a decision to apply may be made) when the similarity score is above a threshold. The activations of the current layer are adapted for reduction of undesired tendencies (e.g., debiasing the activations) and passing the adapted activations (e.g., the debiased activations) to the next layer in a sequential manner.

By identifying an undesired tendencies (e.g., bias) subspace using PCA and/or cosine similarity, the method described herein may isolate the most significant directions associated with undesired tendencies (e.g., bias) and/or with data variations. This targeted approach may effectively remove or reduce undesired tendencies (e.g., bias) while preserving other meaningful aspects of the activations.

A potential technical advantage of the approach described with reference to FIG. 5 for reducing or removing undesired tendencies is that the approach is designed to be applied during inference. Application during inference does not necessarily require additional training and/or fine-tuning (and/or weight changes).

Dynamic adaption of the activation values during inference improves performance of a computing device that executes the LLM for inference for generating a response with reduced or eliminated undesired tendencies, for example, by reducing computational overhead and/or latency, reduced processor utilization, and/or reduced data storage requirements, in comparison to other approaches implemented during training and/or fine-tuning.

The approach of selectively dynamically adapting activations described with reference to 512 may provide potential advantages, for example, the mitigation of potential critical information loss that might otherwise occur if the dynamic adaptation (e.g., debiasing) were applied uniformly.

In another example, performance of the computer executing the LLM during inference is improved by optimizing for higher computational resources utilization by avoiding redundant operations on layers that do not contribute substantially to bias. The performance of the computer may be improved, for example, by relatively reduced utilization of processing resources, reduced processing time, and/or reduced storage requirement, in comparison to dynamically adapting all activations (or more activations).

An example based on features 502-512 is now provided:

Suppose R=2 and we are treating layer l.

$${h}^{( l )} ( x ) = ( \begin{matrix}1.5 \\ 2. \\ 0.5 \\ 0.8\end{matrix} ) and {E}_{bias}^{( l )} ( \begin{matrix}0.7 & 0.2 \\ 0.7 & - 0.3 \\ 0.1 & 0.9 \\ 0.1 & 0.3\end{matrix} ) .$$

The projection coefficients are computed:

$${( {E}_{bias}^{( l )} )}^{T} {h}^{( l )} ( x ) = ( \begin{matrix}2.58 \\ 0.39\end{matrix} )$$

The Gram matrix inverse is computed:

$${( {( {E}_{bias}^{( l )} )}^{T} {E}_{bias}^{( l )} )}^{- 1} = ( \begin{matrix}1.0024 & - 0.0487 \\ - 0.0487 & 0.9732\end{matrix} )$$

Multiply to get the coefficients:

$${( {( {E}_{bias}^{( l )} )}^{T} {E}_{bias}^{( l )} )}^{- 1} {( {E}_{bias}^{( l )} )}^{T} {h}^{( l )} ( x ) = ( \begin{matrix}2.5673 \\ 0.254\end{matrix} )$$

The undesired tendencies (e.g., bias) computed is denoted:

$${E}_{bias}^{( l )} ( \begin{matrix}2.5673 \\ 0.254\end{matrix} ) = ( \begin{matrix}1.8479 \\ 1.7209 \\ 0.4853 \\ 0.3329\end{matrix} )$$

The debiased activation, that is passed to the next layer, becomes:

$${\hat{h}}^{( l )} ( x ) = {h}^{( l )} ( x ) - ( \begin{matrix}1.8479 \\ 1.7209 \\ 0.4853 \\ 0.3329\end{matrix} ) = ( \begin{matrix}1.5 \\ 2. \\ 0.5 \\ 0.8\end{matrix} ) - ( \begin{matrix}1.8479 \\ 1.7209 \\ 0.4853 \\ 0.3329\end{matrix} ) = ( \begin{matrix}- 0.352 \\ 0.28 \\ 0.0147 \\ 0.4661\end{matrix} ) .$$

At 514, a response by the adapted LLM with reduced undesired tendencies is obtained. Feature 514 may correspond to and/or be implemented in association with, feature 222 described with reference to FIG. 2.

Referring back to FIG. 2, at 222, a response to the input prompt is generated by the LLM. The response is expected to be free of undesired tendencies, or displaying reduced undesired tendencies.

The response may be provided, for example, presented on a display, forwarded to another device, stored on a data storage device, fed into another executing process, and the like.

At 224, one or more features described with reference to 202-222 may be iterated. For example, the adapted LLM may be evaluated using one or more metrics described with reference to 202. An insufficiently adapted LLM may be further adapted to obtain a target reduction or removal of undesired tendencies.

Additional exemplary embodiments for adaptive debiasing (e.g., or other undesired tendencies) a LLM are now described.

An exemplary method for debiasing a trained LLM, based on a task vector, comprises: training a proxy model to amplify bias while maintaining utility using a weighted loss function over an ambiguous dataset D^{amb}, an unambiguous dataset D^{unamb}, and a utility dataset D^{utility}, resulting in weight vector θ^{bias}, computing a bias task vector V_{bias}=θ^{bias}−θ⁰, where θ⁰ represents the original pretrained model weights and θ^{bias} represents the biased model, and applying task vector negation to the original model, yielding a debiased model as follows: θ^{debias}=θ⁰−λ_{debias}V_{bias} where λ_{debias} is a scaling factor controlling the extent of debiasing.

Another exemplary method for debiasing a trained LLM is based on task vector reinforcement. The method comprises: training a proxy model to attenuate bias while maintaining utility using a weighted loss function over an ambiguous dataset D^{amb}, an unambiguous dataset D^{unamb}, and a utility dataset D^{utility}, resulting in weight vector θ^{unbias}, computing an unbias task vector as: V_{unbias}=θ_{unbias}−θ₀ where θ^{unbias} represents the unbiased model, and applying the task vector additively to the original model to reinforce unbiased responses: θ^{debias}=θ⁰+λ_{debias}V_{unbias}.

Yet another exemplary method for debiasing a trained LLM is based on a combination of task vectors. The method comprises: training a proxy model to amplify bias while maintaining utility using a weighted loss function over an ambiguous dataset D^{amb}, an unambiguous dataset D^{unamb}, and a utility dataset D^{utility}, resulting in weight vector θ^{bias}, computing a bias task vector V_{bias}=θ^{bias}−θ⁰, where θ⁰ represents the original pretrained model weights and θ^{bias} represents the biased model, training another proxy model to attenuate bias while maintaining utility using a weighted loss function over an ambiguous dataset D^{amb}, an unambiguous dataset D^{unamb}, and a utility dataset D^{utility}, resulting in weight vector θ^{unbias}, computing an unbias task vector as: V_{unbias}=θ^{unbias}−θ⁰ where θ^{unbias} represents the unbiased model, and obtaining a combined debias model

$${θ}^{debias} = {θ}^{0} - {λ}_{debias}^{bias} {V}_{bias} + {λ}_{debias}^{unbias} {V}_{unbias}$$

where the coefficients

$${λ}_{debias}^{bias} and {λ}_{debias}^{unbias}$$

are scaling hyperparameters that control the extent of debiasing to prevent overcorrection.

Yet another exemplary method for debiasing a trained LLM is based on neural activations debiasing via PCA projection. The method for debiasing a trained LLM operating at the activation level comprises: collecting biased activations for a selected layer l over an ambiguous dataset D^{amb} and forming an activation matrix:

$${H}^{( l )} = [ {h}^{( l )} ( {x}_{amb , 1} ) ; ... ; {h}^{( l )} ( {x}_{amb , \vert {D}^{amb} \vert} ) ] ∈ {ℝ}^{{d}_{l} \times \vert {D}^{amb} \vert} ,$$

where dₗ is the activation's dimension for that layer l, computing the mean bias vector

$${h}_{mean}^{( l )} = \frac{1}{\vert {D}^{amb} \vert} {\sum }_{i = 1}^{\vert {D}^{amb} \vert} {h}^{( l )} ( {x}_{amb , i} ) ,$$

centering the activation matrix as

$${\tilde{H}}^{( l )} = {H}^{( l )} - {h}_{mean}^{( l )} \cdot {1}^{T} ,$$

computing the sample covariance matrix

$${C}_{H}^{l} = \frac{1}{\vert {D}^{amb} \vert} {\tilde{H}}^{( l )} * {( {\tilde{H}}^{( l )} )}^{T} ∈ {ℝ}^{{d}_{l} \times {d}_{l}} ,$$

and performing Eigen decomposition to obtain eigenvalues

$$\{ {μ}_{i}^{( l )} \}$$

and corresponding eigenvectors

$$\{ {e}_{i}^{( l )} \} for {C}_{H}^{l} ,$$

selecting from the eigenvectors those that are most aligned with the bias by computing the cosine similarity for each

$${sim}_{i} = \frac{{e}_{i}^{( l )} \cdot {h}_{bias}^{( l )}}{‖ {e}_{i}^{( l )} ‖ ‖ {h}_{bias}^{( l )} ‖} ,$$

and forming a bias subspace matrix

$${E}_{bias}^{( l )}$$

by concatenaung those eigenvectors with similarity above a threshold η, and given a new input x, calculating the debiased activations in a sequential manner. Specifically, for each layer its original activation vector h^{(l)}(x) is computed and the bias component is subtracted as follows:

$${\hat{h}}^{( l )} ( x ) = {h}^{( l )} ( x ) - {{E}_{bias}^{( l )} ( {( {E}_{bias}^{( l )} )}^{T} {E}_{bias}^{( l )} )}^{- 1} {( {E}_{bias}^{( l )} )}^{T} {h}^{( l )} ( x ) .$$

The resulting debiased activations ĥ^{(l)}(x) are then used in subsequent processing within the LLM, thereby mitigating bias without modifying the original network weights.

Yet another exemplary method for debiasing a trained LLM is based on targeted task vector debiasing. The method wherein a targeted task vector application is limited to a subset of the most relevant network parameters, determined using an inspired-by PCGU approach, is as follows: computing the full task vector U∈ [symbol] ^{|θ|}, where |θ| represents the number of tunable model parameters, and defining a targeted task vector U′ (II) where:

$${U}_{i}^{′} ( \prod ) = \{ \begin{matrix}{U}_{i} , & if i ∈ \prod \\ 0 , & o . w .\end{matrix}$$

and Π represents the set of selected indices of parameters to modify, and selecting Π using one of the following strategies:
Highest Magnitude Weights: Selecting the top k parameters with the highest absolute values in U, such that:
Πₜₒₚ₋ₖ={i|Uᵢ is among the top k highest magnitude values in U}
Highest Ratio Selection: Selecting a fraction r of the most influential parameters, such that:
Πᵣ={i|Uᵢ is among the top (r·|θ|) highest magnitude values in U}
Any other scheme that one skilled in the art deems fitting, and applying the targeted task vector instead of the full vector to modify only the most significant parameters.

Yet another exemplary method for debiasing a trained LLM is based on adaptive selection of k for targeted task vector application. A method wherein a targeted task vector application is limited to a subset of the most relevant network parameters, determined using an inspired-by PCGU approach, wherein the number of targeted parameters k is determined dynamically based on gradient distribution properties, using one of the following techniques:
Knee Point Detection (Elbow Method):
   Sorting the absolute values of task vector elements in descending order.
   Identifying the knee point as the optimal k*:

$$k *= {argmax}_{k} ( \frac{{U}_{k - 1} - {U}_{k}}{{U}_{1} - {U}_{\vert θ \vert}} )$$

Selecting the subset of parameters based on this detected k*.
Variance-Based Selection:
   Computing the cumulative variance function:

$$C ( k ) = \frac{{\sum }_{i ∈ \{ 1 , … k \}} {U}_{i}^{2}}{{σ}_{total}^{2}} , where {σ}_{total}^{2} = {\sum }_{i ∈ \{ 1 , … \vert θ \vert \}} {U}_{i}^{2}$$

Selecting the smallest k* such that: C(k*)≥τ where τ is a predefined threshold (e.g., 0.9), ensuring that most impactful parameters are retained.
Any other approach that one skilled in the art may deem appropriate.

Yet another exemplary method for debiasing a trained LLM is based on bias evaluation for performance-guided task vector application. A method wherein bias reduction effectiveness is empirically validated to determine the best k, comprising: selecting a set of candidate k values {k₁, k₂, . . . , kₙ}, applying targeted task vector unlearning for each k∈{k₁, k₂, . . . , kₙ}, measuring bias scores using bias evaluation metrics (e.g. accuracy or bias score measured on BBQ as described herein), and selecting the smallest k* that minimizes bias while maintaining general model performance.

In an integrated approach for reducing generation of undesired tendencies, the approach of using the vector(s) (e.g., task vector debiasing) described herein may be combined with the approach of activation negation to address generation of undesired tendencies at different levels of the LLM. The vector approach may operate at the parameter level by adjusting the LLM weights, while the activation negation approach may operate at the representational (neuron) level during inference. In combination, these approaches provide complementary mechanisms to reduce generation of undesired tendencies without sacrificing model utility.

Using the first vector and/or second vector described herein for reduction of undesired tendencies an undesired tendencies (e.g., debiased) parameter set may be computed using a weighted combination of the first vector and/or second vector described herein (e.g., bias and unbias task vectors):

$${θ}^{debias} = {θ}^{0} - {λ}_{debias}^{bias} {V}_{bias} + {λ}_{debias}^{unbias} {V}_{unbias}$$

Where the coefficients

$${λ}_{debias}^{bias} and {λ}_{debias}^{unbias}$$

denote scaling hyperparameters that control the extent of debiasing to prevent overcorrection. This correction may be done offline, prior to model inference.

After forming

$${θ}^{debias} , {E}_{bias}^{( l )}$$

is computed for layers l∈{1, . . . , L} in preparation for the inference time debiasing, as described herein. Then, activation negation activation negation is applied during inference. This further mitigates the remaining bias present in θ^{debias}.

Yet another exemplary method for debiasing a trained LLM is based on the logits of the LLM. Logits are the raw, unnormalized scores output by a model. Formally, logits are a sequence (or vector) of real numbers ( [symbol] ), one for each class in a classification task. One can debias a LLM by applying the above activations-related method on the logits, rather than on the neural activations of intermediate layers, as we detail in the next paragraphs.

The method comprises: computing for the logits layer denoted l_{logits} the biased logits matrix H^{(l}^{_{logits}}⁾, and its mean vector

$${h}_{mean}^{( {l}_{logits} )} .$$

Then, performing PCA on the biased logits matrix to obtain eigenvectors

$$\{ {e}_{i}^{( {l}_{logits} )} \} ,$$

and calculating the mean bias direction

$${h}_{bias}^{( {l}_{logits} )} = \frac{1}{\vert {D}^{amb} \vert} {\sum }_{( {x}_{amb} , {y}_{bias} , {y}_{unk} ) ∈ {D}^{amb}} {h}^{( {l}_{logits} )} ( {x}_{amb} ) -$$

$$\frac{1}{\vert {D}^{unamb} \vert} {\sum }_{( {x}_{unamb} , {y}_{unbias} , {y}_{unk} ) ∈ {D}^{unamb}} {h}^{( {l}_{logits} )} ( {x}_{unamb} ) .$$

This calculation is done offline, i.e., prior to the deployment of the LLM.

For a new input x, operate as follows. First, if the logits h^{(l}^{_{logits}}⁾(x) are not available, compute them from the k log probabilities, as specified subsequently. Then, the cosine similarity score with the mean bias direction

$${h}_{bias}^{( {l}_{logits} )}$$

may be computed as:

$${score}_{i} = \frac{{h}^{( {l}_{logits} )} ( x ) \cdot {h}_{bias}^{( {l}_{logits} )}}{‖ {h}^{( {l}_{logits} )} ( x ) ‖ ‖ {h}_{bias}^{( {l}_{logits} )} ‖} .$$

If scoreₗ<ω_{logits}, where ω_{logits} the logits layer's threshold, we skip the debiasing and retain the original logits. Otherwise, debiasing is performed as follows. First, we subtract the mean bias direction

$${h}_{bias}^{( {l}_{logits} )}$$

from the logits. Second, we compare these debiased logits to the ones originally observed and deduce a logit bias factor per token, i.e., some correction factor added to each token. Third, we add the logit bias factors and generate the next token. We repeat this process until the end of the generated sentence.

So far, we have assumed full access to the model's weights and activations. Yet, in some cases, LLM operators may not provide direct access to the logits. In such cases, we assume access to only k (e.g., 5) most probable log probabilities of the model rather than the logits from which probabilities were derived.

The log probabilities are the logarithm of the normalized probabilities that one gets after applying a function, e.g., Softmax, to the logits. Based on these k log probabilities, we propose to compute an estimate of the top k logits by adding a constant, say C, which is added uniformly to all k log probabilities.

We refer to the logits' estimate computed this way by the term pseudo-logits and use them in the calculations instead of the logits or the neural activations. The choice of the constant C may be done in several ways such as a predetermined constant (a hyperparameter), a percentage of the total log probs values when C=0 is assumed, or other methods apparent to those versed in the art.

Next, to complete missing logits (so that we have more than the top k), we estimate the other logits using an open-source LLM (like a Llama model). One way to do so, is to first generate all logits using an open-source model, denoting logit^{os}(i) as the ith logit of the open-source model. Similarly, denote the logits of the target model as logit^{model}(i). Then, to convert the open-source logits to the target model missing logits, we need to weigh their relative importance by the excess probability of the target model. This is done by computing the next transformation for each logit:

$$\text{?} ι {t}^{model} ( i ) = {logit}^{os} ( i ) * \frac{{p}_{excess}^{model}}{{p}_{excess}^{os}} ,$$

$${p}_{excess}^{model} = 1 - {\sum }_{i ∈ TopK} \frac{{e}^{{logit}^{model} ( i )}}{\sum {e}^{{logit}^{model} ( i )}}$$

$${p}_{e x c e s s}^{o s} = 1 - {\sum }_{i ∈ T o p K} \frac{{e}^{{logit}^{o s} ( i )}}{\sum {e}^{{logit}^{o s} ( i )}}$$

With [symbol] it^{model}(i) denoting the estimate of the real logit logit^{model}(i), and TopK being the indices of the top k logits.

Note that here we formulated one method to estimate the missing logits. However, one versed in the art may employ different heuristics. In the case of limited access to an LLM, we assume the existence of a mapping function from a token value (such as ‘pa’) to its corresponding token ID (such as 1410). This ability allows one to alter the logits that the model produces at inference, reducing the model's tendency to produce undesired tokens. This is done by using the logit_bias parameter, or a similar parameter with a different name, which is a model API parameter that lets one manipulate the probability distribution over tokens during generation-by adding a custom bias term per logit before sampling. Here, once we determine a bias factor per logit, we transform these factors into logit_bias per token entries. As we may have no access to logits through the API, the transformation is determined experimentally as part of the pre-deployment stage by observing actual bias elimination with various transformation schemes, which are apparent to those versed in the art.

Yet another exemplary method for debiasing a trained LLM is based on neural activations, optionally adaptive neural activations debiasing via cosine thresholding. The method comprises: computing, for a given layer l, the biased activation matrix H^{(l)} and its mean vector

$${h}_{m e a n}^{( l )} .$$

Then, performing PCA on the biased activation matrix to obtain Eigenvectors

$$\{ {e}_{i}^{( l )} \} ,$$

and calculating the mean bias direction

$${h}_{bias}^{( l )} = \frac{1}{\vert {D}^{amb} \vert} {\sum }_{( {x}_{amb} , {y}_{bias} , {y}_{unk} ) ∈ {D}^{amb}} {h}^{( l )} ( {x}_{amb} ) - \frac{1}{\vert {D}^{unamb} \vert} {\sum }_{( {x}_{unamb} , {y}_{unbias} , {y}_{unk} ) ∈ {D}^{unamb}} {h}^{( l )} ( {x}_{unamb} )$$

For a new input x, operate in a sequential manner over the LLM's layers, deciding for each layer if to debias it or not. Formally, the cosine similarity score with the mean bias direction

$${h}_{b i a s}^{( l )}$$

may be computed as:

$${score}_{l} = \frac{{h}^{( l )} ( x ) \cdot {h}_{b i a s}^{( l )}}{‖ {h}^{( l )} ( x ) ‖ ‖ {h}_{b i a s}^{( l )} ‖} .$$

If scoreₗ<ωₗ, where ωₗ is a threshold set for each layer, skip the debiasing for layer/and retain the original activations. Otherwise, continue as described herein, debiasing the activations and passing ĥ^{(l)}(x) to the next layer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant LLMs will be developed and the scope of the term LLM is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of adapting a large language model (LLM) for generating reduced undesired tendencies in responses to prompts, comprising:
generating a reduced undesired tendencies LLM by training a LLM that generates at least some undesired tendencies using a first training dataset that is used to exclude or reduce undesired tendencies;
computing a first vector as a difference between weights of the reduced undesired tendencies LLM and weights of a version of the LLM prior to the training;
extracting a portion of the first vector that is less than or equal to a complete form of the first vector;
adding the portion of the first vector to the version of the LLM prior to the training for generating an adapted LLM designed to generate reduced undesired tendencies in responses; and
providing the adapted LLM for generating reduced undesired tendencies in responses.

2. The computer implemented method of claim 1, wherein the portion of the first vector is extracted by applying a scaling hyperparameter to the first vector, wherein a value of the scaling hyperparameter is selected to determine an amount of the portion that is extracted from the first vector to prevent overcorrection of the LLM.

3. The computer implemented method of claim 1, wherein the first training dataset includes ambiguous records, unambiguous records, and neutral utility records, wherein the reduced undesired tendencies LLM is trained using an objective function including a first loss component designed to align predictions by the LLM with prompts exhibiting unknowns by minimizing cross-entropy loss over the ambiguous records according to a target corresponding to an unknown answer, a second loss component designed to retain performance over the unambiguous records, and a third loss component designed to preserve utility on neutral utility questions.

4. The computer implemented method of claim 1, further comprising:
generating an increased undesired tendencies LLM by training the LLM that generates undesired tendencies on a second training dataset that includes undesired tendencies resulting in an increased undesired tendencies LLM;
computing a second vector as a difference between weights of the increased undesired tendencies LLM and weights of the version of the LLM prior to the training;
computing a negation of the second vector;
computing a combination vector comprising a combination of the portion of the first vector and the negation of the second vector; and
wherein adding the portion of the first vector to the version of the LLM prior to the training comprises adding the combination vector to the version of the LLM prior to the training for generating the adapted LLM.

5. The computer implemented method of claim 4, wherein the first vector is computed such that a first direction of the first vector is substantially opposite angle-wise to a second direction of the second vector.

6. The computer implemented method of claim 4, wherein the second training dataset includes ambiguous records, unambiguous records, and neutral utility records, wherein the increased undesired tendencies LLM is trained using an objective function including a first loss component designed to minimize loss over the ambiguous records, a second loss component designed to retain performance over the unambiguous records, and a third loss component designed to preserve utility on neutral utility questions.

7. The computer implemented method of claim 6, wherein each of the first loss component, the second loss component and the third loss component are associated with different hyperparameters that control the relative importance of each component and the hyperparameters sum to one.

8. The computer implemented method of claim 6, wherein each ambiguous record include a first triplet including an ambiguous prompt that is insufficient for determining a correct response, a response exhibiting an undesired tendency, and an indication of uncertainty, wherein each unambiguous records includes a second triplet including an unambiguous prompt that is sufficient for determining a correct response, the correct response, and an indication of uncertainty, and a neutral utility record includes a pair of general knowledge question and answer.

9. The computer implemented method of claim 4, further comprising:
selecting a first subset of indices corresponding to LLM weights of the combination vector for adaptation of corresponding weights of the LLM; and
zeroing indices excluded from the first subset.

10. The computer implemented method of claim 9, wherein the first subset is selected according to indices corresponding to a predefined number of weights and/or predefined percentage of the LLM with highest magnitude absolute values.

11. The computer implemented method of claim 9, wherein the number of predefined weights for selection in the first subset are selected by:
(i) plotting magnitudes of absolute values of the indices in descending order, and identifying a region stretch after which a drop-off is largest, the region stretch's end corresponding to the number;
(ii) selecting a smallest value of the number such that the selected indices explain a predefined fraction of a variance of the total indices;
(iii) selecting a set of candidate values for the predefined number, applying each set to the adapted LLM, measuring scores indicative of undesired tendencies for each applied set, and selecting a smallest value of the candidate values which generates minimal undesired tendencies.

12. The computer implemented method of claim 1, further comprising:
wherein the LLM is implemented as a neural network arranged in a plurality of layers including a plurality of neurons;
for at least one layer of the plurality of layers, identifying a subset of a plurality of neuron activations correlated with captured latent undesired tendencies;
generating a respective undesired tendencies subspace matrix for each respective layer from the corresponding subset of the plurality of neuron activations of the respective layer; and
during inference of a new input prompt by the adapted LLM, sequentially applying the respective undesired tendencies subspace matrix to the corresponding neural activations of the respective layer, for obtaining a response by the adapted LLM with reduced undesired tendencies.

13. The computer implemented method of claim 12, wherein the subset of the plurality of neuron activations correlated with captured latent undesired tendencies is identified by:
feeding into the adapted LLM, a plurality of first prompt including undesired tendencies or designed to trigger a response with undesired tendencies by the adapted LLM;
for each layer of the plurality of layers of the adapted LLM, computing a first aggregation of neuron activations in response to the feeding of the first prompt;
feeding into the adapted LLM, a plurality of second prompt excluding undesired tendencies or designed to trigger a response that excludes undesired tendencies by the adapted LLM;
for each layer of the plurality of layers of the adapted LLM, computing a second aggregation of neuron activations in response to the feeding of the second prompt; and
for each layer of the plurality of layers of the adapted LLM, computing a difference between the first aggregation and the second aggregation, the difference indicative of undesired tendencies in the adapted LLM.

14. The computer implemented method of claim 12, further comprising:
applying a principal component analysis (PCA) on the plurality of layers in response to the feeding of the first prompt into the adapted LLM;
for each layer of the plurality of layers:
computing a sample covariance matrix;
performing Eigen decomposition on the sample covariance matrix to obtain a plurality of eigenvectors and respective eigenvalues;
measuring an alignment of each eigenvector with an overall direction of undesired tendencies by computing a cosine similarity with an aggregated vector of undesired tendencies; and
selecting a subset of eigenvectors associated with the cosine similarity above a preset threshold,
wherein the undesired tendencies subspace matrix is generated from the subset of eigenvectors.

15. The computer implemented method of claim 12, wherein applying the undesired tendencies subspace matrix comprises sequentially projecting each layer of the plurality of layers onto the undesired tendencies subspace matrix to obtain a projection, and subtracting the projection from the corresponding original activation, for obtaining a response by the adapted LLM with reduced undesired tendencies.

16. The computer implemented method of claim 12, wherein applying comprises selectively applying the undesired tendencies subspace matrix to the adapted LLM during inference of the new input prompt by: sequentially computing activations at each layer in response to the new input prompt and deciding for each layer whether to apply the undesired tendencies subspace matrix to the layer or not and applying the original activations to the next layer.

17. The computer implemented method of claim 16, further comprising:
computing a similarity score between an original aggregated direction of undesired tendencies and values of the undesired tendencies subspace matrix in response to the new input prompt; and
deciding to apply the undesired tendencies subspace matrix when the similarity score is above a threshold, and not applying the undesired tendencies subspace matrix when the similar score is below the threshold,
wherein the threshold includes a per-layer hyperparameter indicating significance of an undesired tendencies component of each respective layer.

18. The computer implemented method of claim 1, wherein the undesired tendencies comprise displaying bias in content generated by the adapted LLM.

19. The computer implemented method of claim 18, wherein bias is selected from:
gender, race, age-related, body shape and religion.

20. The computer implemented method of claim 1, wherein the training dataset includes records each associated with a binary label indicating an undesired tendency or a non-undesired tendency.

21. The computer implemented method of claim 1, wherein an architecture of the LLM is selected from: decoder-only transformer model, encoder-decoder transformer model, Low-rank adapted (LoRA) and parameter efficient tuned (PEFT) models, autoregressive language model, and masked language model (MLM), and a transformer-based language model.

22. The computer implemented method of claim 1, wherein the training dataset includes one or more of: multiple-choice question answering, cloze-style tasks, and analogy-based prompts.

23. A system for adapting a large language model (LLM) for generating reduced undesired tendencies in responses to prompts, comprising:
at least one processor executing a code for:
generating a reduced undesired tendencies LLM by training a LLM that generates at least some undesired tendencies on a first training dataset that excludes undesired tendencies;
computing a first vector as a difference between weights of the reduced undesired tendencies LLM and weights of a version of the LLM prior to the training;
extracting a portion of the first vector that is less than a complete form of the first vector;
applying the portion of the first vector to the version of the LLM prior to the training for generating an adapted LLM designed to generate reduced undesired tendencies in responses; and
providing the adapted LLM for generating reduced undesired tendencies in responses.

24. A non-transitory medium storing program instructions for adapting a large language model (LLM) for generating reduced undesired tendencies in responses to prompts, which when executed by at least one processor, cause the at least one processor to:
generate a reduced undesired tendencies LLM by training a LLM that generates at least some undesired tendencies on a first training dataset that excludes undesired tendencies;
compute a first vector as a difference between weights of the reduced undesired tendencies LLM and weights of a version of the LLM prior to the training;
extract a portion of the first vector that is less than a complete form of the first vector;
apply the portion of the first vector to the version of the LLM prior to the training for generating an adapted LLM designed to generate reduced undesired tendencies in responses; and
provide the adapted LLM for generating reduced undesired tendencies in responses.
